(19) United States
(12) Patent Application Publication
(10) Pub. No.: US 2021/0105313 A1
(43) Pub. Date: Apr. 8, 2021

(54) METHODS AND APPARATUS FOR SIGNALING A REGION IN SPATIALLY GROUPED IMMERSIVE MEDIA DATA TRACKS

(71) Applicant: MEDIATEK Singapore Pte. Ltd., Singapore (SG)

(72) Inventors: Xin Wang, San Jose, CA (US); Lulin Chen, San Jose, CA (US)

(73) Assignee: MEDIATEK Singapore Pte. Ltd., Singapore (SG)

(21) Appl. No.: 17/035,646

(22) Filed: Sep. 28, 2020

Related U.S. Application Data
(60) Provisional application No. 62/909,258, filed on Oct. 2, 2019.

(51) Int. Cl. H04L 29/06; H04N 19/70; H04N 19/44

(52) U.S. Cl. CPC H04L 65/80; H04L 65/607; H04N 19/44; H04N 19/70

(57) ABSTRACT

The techniques described herein relate to methods, apparatus, and computer readable media configured to encode and/or decode video data. Immersive media data includes a first patch track comprising first encoded immersive media data that corresponds to a first spatial portion of immersive media content, a second patch track comprising second encoded immersive media data that corresponds to a second spatial portion of the immersive media content different than the first spatial portion, an elementary data track comprising first immersive media elementary data, wherein the first patch track and/or the second patch track reference the elementary data track, and grouping data that specifies a spatial relationship between the first patch track and the second patch track in the immersive media content. An encoding and/or decoding operation is performed based on the first patch track, the second patch track, the elementary data track and the grouping data to generate decoded immersive media.

### RELATED APPLICATIONS

This Application claims priority under 35 U.S.C. § 119(e) to U.S. Provisional Application Ser. No. 62/909,258, titled “METHODS OF SIGNALLING 3D SOURCES, REGIONS AND VIEWPORTS IN ISOBMFF AND DASH,” and filed Oct. 2, 2019, which is herein incorporated by reference in its entirety.

### TECHNICAL FIELD

The techniques described herein relate generally to video coding, and particularly to methods and apparatus for signaling regions in spatially grouped immersive media data tracks.

### BACKGROUND OF INVENTION

Various types of video content, such as 2D content, 3D content and multi-directional content exist. For example, omnidirectional video is a type of video that is captured using a set of cameras, as opposed to just a single camera as done with traditional unidirectional video. For example, cameras can be placed around a particular center point, so that each camera captures a portion of video on a spherical coverage of the scene to capture 360-degree video. Video from multiple cameras can be stitched, possibly rotated, and projected to generate a projected two-dimensional picture representing the spherical content. For example, an equal rectangle projection can be used to put the spherical map into a two-dimensional image. This can be done, for example, to use two-dimensional encoding and compression techniques. Ultimately, the encoded and compressed content is stored and delivered using a desired delivery mechanism (e.g., thumb drive, digital video disk (DVD) and/or online streaming). Such video can be used for virtual reality (VR), and/or 3D video.

At the client side, when the client processes the content, a video decoder decodes the encoded video and performs a reverse-projection to put the content back onto the sphere. A user can then view the rendered content, such as using a head-worn viewing device. The content is often rendered according to the user's viewport, which represents the angle at which the user is looking at the content. The viewport may also include a component that represents the viewing area, which can describe how large, and in what shape, the area is that is being viewed by the viewer at the particular angle.

When the video processing is not done in a viewport-dependent manner, such that the video encoder does not know what the user will actually view, then the whole encoding and decoding process will process the entire spherical content. This can allow, for example, the user to view the content at any particular viewport and/or area, since all of the spherical content is delivered and decoded.

However, processing all of the spherical content can be compute intensive and can consume significant bandwidth. For example, for online streaming applications, processing all of the spherical content can place a large burden on network bandwidth. Therefore, it can be difficult to preserve a user's experience when bandwidth resources and/or compute resources are limited. Some techniques only process the content being viewed by the user. For example, if the user is viewing the front (e.g., or north pole), then there is no need to deliver the back part of the content (e.g., the south pole). If the user changes viewports, then the content can be delivered accordingly for the new viewport. As another example, for free viewpoint TV (FTV) applications (e.g., which capture video of a scene using a plurality of cameras), the content can be delivered depending at which angle the user is viewing the scene. For example, if the user is viewing the content from one viewport (e.g., camera and/or neighboring cameras), there is probably no need to deliver content for other viewports.

### SUMMARY OF INVENTION

In accordance with the disclosed subject matter, apparatus, systems, and methods are provided for processing (e.g., encoding or decoding) point cloud video data and/or other 3D immersive media in an immersive media data structure.

Some embodiments relate to a decoding method for decoding video data for immersive media. The method includes accessing immersive media data including a set of tracks, wherein each track of the set of tracks comprises associated to-be-decoded immersive media data that corresponds to an associated spatial portion of immersive media content that is different than the associated spatial portions of other tracks in the set of tracks; an elementary data track comprising first immersive media elementary data, wherein at least one track of the set of tracks references the elementary data track; grouping data that specifies a spatial relationship among the tracks in the set of tracks in the immersive media content; and region metadata comprising data that specifies a spatial relationship between a viewing region in the immersive media content and a subset of tracks of the set of tracks, wherein each track in the subset of tracks contributes at least a portion of the visual content of the region. The method also includes performing a decoding operation based on the set of tracks, the elementary data track, the grouping data, and the region metadata to generate decoded immersive media data.

In some examples, accessing the immersive media data includes accessing an immersive media bitstream including a set of patch tracks, wherein each patch track corresponds to an associated track in the set of tracks; and the elementary data track, wherein each patch track in the set of patch tracks references the elementary data track. In some examples, accessing the immersive media data includes accessing a set of immersive media bitstreams, wherein each immersive media bitstream comprises a track from the set of tracks; and an associated elementary data track, wherein the track references the associated elementary data track, such that an immersive media bitstream from the set of immersive media bitstreams comprises the elementary data track.

In some examples, the region includes a sub-portion of the viewable immersive media data that is less than a full viewable portion of the immersive media data. In some examples, the region includes a viewport.

In some examples, accessing the region metadata includes accessing a track grouping box in each track in the set of tracks. In some examples, accessing the region metadata includes accessing a timed metadata track that references the subset of tracks.

In some examples, accessing the immersive media data includes accessing a streaming manifest file that includes a track representation for each track in the set of tracks.

In some examples, each track representation is associated with a set of component track representations.

In some examples, the streaming manifest file includes a descriptor that specifies the region metadata. In some examples, the streaming manifest file includes a timed metadata representation for a timed metadata track comprising the region metadata.

In some examples, the immersive media content includes point cloud multimedia.

In some examples, the elementary data track includes at least one geometry track including geometry data of the immersive media; at least one attribute track including attribute data of the immersive media; and an occupancy track comprising occupancy map data of the immersive media and accessing the immersive media data comprises accessing: the geometry data in the at least one geometry track; the attribute data in the at least one attribute track; and the occupancy map data of the occupancy track; and performing the decoding operation comprises performing the decoding operation using the geometry data, the attribute data, and the occupancy map data, to generate the decoded immersive media data.

Some embodiments relate to an encoding method for encoding video data for immersive media. The method includes encoding immersive media data, including encoding at least a set of tracks, wherein each track of the set of tracks comprises associated to-be-encoded immersive media data that corresponds to an associated spatial portion of immersive media content that is different than the associated spatial portions of other tracks in the set of tracks; an elementary data track including first immersive media elementary data, wherein at least one track of the set of tracks references the elementary data track; grouping data that specifies a spatial relationship among the tracks in the set of tracks in the immersive media content; and region metadata comprising data that specifies a spatial relationship between a viewing region in the immersive media content and a subset of tracks of the set of tracks, wherein each track in the subset of tracks contributes at least a portion of the visual content of the region.

In some examples, encoding the immersive media data includes encoding an immersive media bitstream including a set of patch tracks, wherein each patch track corresponds to an associated track in the set of tracks; and the elementary data track, wherein each patch track in the set of patch tracks references the elementary data track.

In some examples encoding the immersive media data includes encoding a set of immersive media bitstreams, wherein each immersive media bitstream includes a track from the set of tracks; and an associated elementary data track, wherein the track references the associated elementary data track, such that an immersive media bitstream from the set of immersive media bitstreams includes the elementary data track.

In some examples, encoding the region metadata includes encoding a track grouping box in each track in the set of tracks. In some examples, encoding the region metadata includes encoding a timed metadata track that references the subset of tracks.

In some examples, encoding the immersive media data includes encoding a streaming manifest file that includes a track representation for each track in the set of tracks.

Some embodiments relate to a non-transitory computer-readable storage medium storing instructions that, when executed by a processor, cause the processor to perform a method. The method includes encoding immersive media data including a set of tracks, wherein each track of the set of tracks includes associated to-be-decoded immersive media data that corresponds to an associated spatial portion of immersive media content that is different than the associated spatial portions of other tracks in the set of tracks; an elementary data track including first immersive media elementary data, wherein at least one track of the set of tracks references the elementary data track; grouping data that specifies a spatial relationship among the tracks in the set of tracks in the immersive media content; region metadata including data that specifies a spatial relationship between a viewing region in the immersive media content and a subset of tracks of the set of tracks, wherein each track in the subset of tracks contributes at least a portion of the visual content of the region. The method also includes performing a decoding operation based on the set of tracks, the elementary data track, the grouping data, and the region metadata to generate decoded immersive media data.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto. It is to be understood that the phraseology and terminology employed herein are for the purpose of description and should not be regarded as limiting.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1 shows an exemplary video coding configuration, according to some embodiments.

FIG. 2 shows a viewport dependent content flow process for VR content, according to some examples.

FIG. 3 shows an exemplary processing flow for point cloud content, according to some examples.

FIG. 4 shows an example of a free-view path, according to some examples.

FIG. 5 is a diagram showing exemplary point cloud tiles, including 3D and 2D bounding boxes, according to some examples.

FIG. 6 is a diagram showing an exemplary octree-based division for 3D sub-volumetric decomposition, according to some embodiments.

FIG. 7 is a diagram showing an exemplary quadtree-based division for 2D sub-picture decomposition, according to some embodiments.

FIG. 8 shows a V-PCC bitstream that is composed of a set of V-PCC units, according to some examples.

FIG. 9 shows an ISOBMFF-based V-PCC container, according to some examples.

FIG. 10 shows an example of a point cloud structure designed to support track derivations, according to some embodiments.

FIG. 11 shows an example of V-PCC patch-level partitioning, according to some embodiments.

FIG. 12 is an exemplary diagram illustrating the association between V-PCC tracks and the component tracks.

FIG. 13 is an exemplary diagram showing three ‘3dcc’ track groups of sub-volumetric tracks based on the exemplary octree-based division for 3D sub-volumetric decomposition shown in FIG. 6, according to some embodiments.

FIG. 14 is an exemplary diagram showing three ‘2dcc’ track groups of sub-volumetric tracks based on the exemplary quadtree-based division for 2D sub-picture decomposition shown in FIG. 7, according to some embodiments

FIG. 15 shows an exemplary method for decoding video data for immersive data, according to some embodiments.

FIG. 16 shows an exemplary method for encoding video data for immersive data, according to some embodiments.

FIG. 17 is an exemplary diagram showing metadata data structures for 3D elements, according to some embodiments.

FIG. 18 is an exemplary diagram showing metadata data structures for 2D elements, according to some embodiments.

FIG. 19 is an exemplary diagram showing metadata data structures for 2D and 3D elements, according to some embodiments.

FIG. 20 is an exemplary diagram showing metadata data structures for 2D and 3D sources, according to some embodiments.

FIG. 21 is an exemplary diagram showing metadata data structures for regions with 2DoF and 6DoFs, according to some embodiments.

FIG. 22 is an exemplary diagram showing metadata data structures for viewports with 3DoF and 6DoFs, according to some embodiments.

FIG. 23 is an exemplary diagram of 2D planar regions with 2DoF, according to some embodiments.

FIG. 24 is an exemplary diagram of a sample entry and sample format for signaling 2D planar regions with 2DoF within timed metadata tracks, according to some embodiments.

FIG. 25 is an exemplary diagram of 3D spherical regions with 6DoF, according to some embodiments.

FIG. 26 is an exemplary diagram of a sample entry and sample format for signaling 3D planar regions with 6DoF within timed metadata tracks, according to some embodiments.

FIG. 27 is an exemplary diagram of 3D planar regions with 6DoF, according to some embodiments.

FIG. 28 is an exemplary diagram of a sample entry and sample format for signaling 2D planar regions with 2DoF within timed metadata tracks, according to some embodiments.

FIG. 29 is an exemplary diagram of 3D tile regions with 6DoF, according to some embodiments.

FIG. 30 is an exemplary diagram of a sample entry and sample format for signaling 3D tile regions with 6DoF within timed metadata tracks, according to some embodiments.

FIG. 31 is an exemplary diagram showing signaling of 2D planar regions with 2DoF spatial relationship of spatial regions in track groups, according to some embodiments.

FIG. 32 is an exemplary diagram showing signaling of 3D spherical regions with 6DoF spatial relationship of spatial regions in track groups, according to some embodiments.

FIG. 33 is an exemplary diagram showing signaling of 3D planar regions with 6DoF spatial relationship of spatial regions in track groups, according to some embodiments.

FIG. 34 is an exemplary diagram showing signaling of 3D tile regions with 6DoF spatial relationship of spatial regions in track groups, according to some embodiments.

FIG. 35 is a diagram of exemplary sample entry and sample format for signaling a viewport with 3DoF (e.g. for 2D faces/tiles in 3D space and/or the like) in timed metadata tracks, according to some embodiments.

FIG. 36 is a diagram of exemplary sample entry and sample format for signaling a viewport with 3DoF (e.g. for 2D faces/tiles in 3D space and/or the like) in timed metadata tracks, according to some embodiments.

FIG. 37A-3B shows an exemplary table of EssentialProperty@value and/or SupplementalProperty@value attributes for the static SRD scheme, according to some embodiments.

FIG. 38 shows an example of a region in a partitioned immersive media stream, according to some embodiments.

FIG. 39 shows an exemplary method 4000 for decoding video data for immersive media, according to some embodiments.

### DETAILED DESCRIPTION OF INVENTION

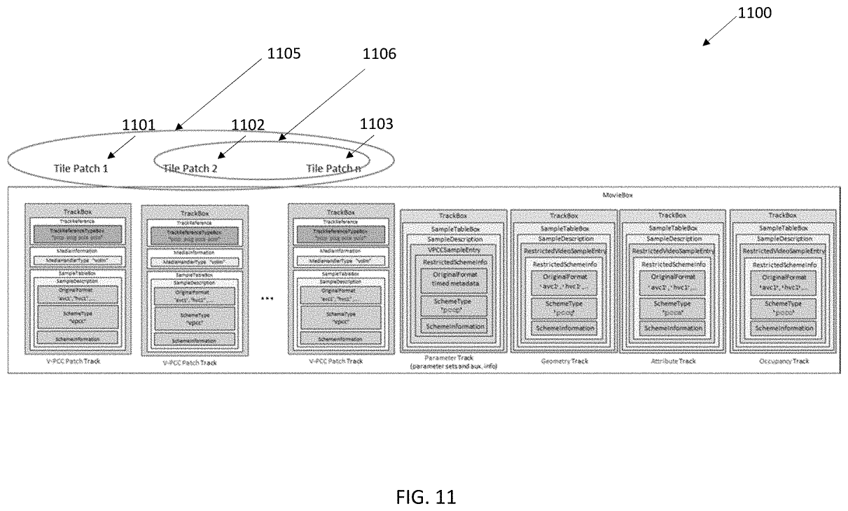

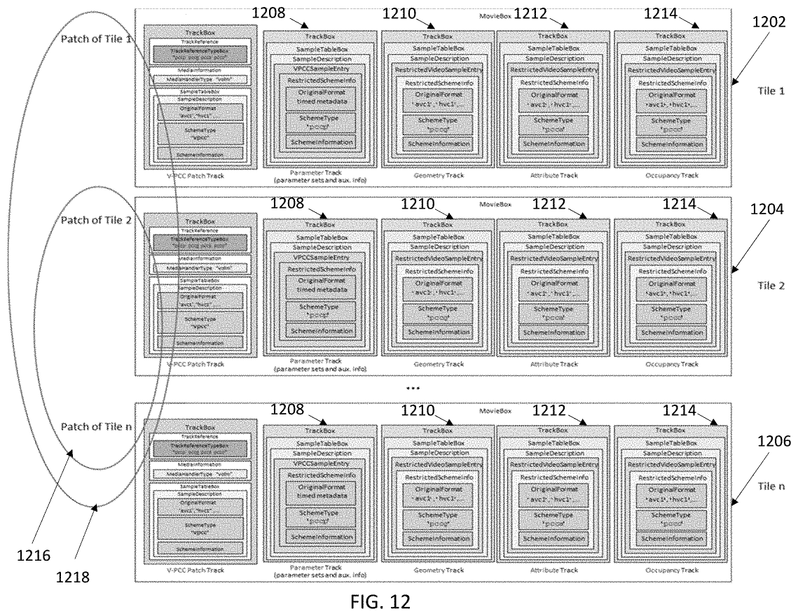

Point cloud data or other immersive media, such as Video-based Point Cloud Compression (V-PCC), data can provide compressed point cloud data for various types of 3D multimedia applications. Conventional storage structures for point cloud content present the point cloud content (e.g., V-PCC component tracks) as a timer-series sequence of units (e.g., V-PCC units) that encode the entire immersive media content of the associated immersive media data, and also include a collection of component data tracks (e.g., geometry, texture, and/or occupancy tracks). Such conventional techniques do not provide for subdividing the point cloud content into smaller portions that are carried by individual units in the storage structures. It can therefore be desirable to provide techniques for encoding and/or decoding different portions of point cloud video data (e.g., using separate bitstreams and/or patch tracks that each encode an associated different portion of the point cloud content). The techniques described herein provide for point cloud content structures that can leverage separate bitstreams and/or separate patch tracks to break up and encode the original immersive media content (e.g., which can include 2D and/or 3D point cloud content). For example, a V-PCC stream can be partitioned/sub-divided/tiled, for the purpose of partial access, into a number of (a) tile/region streams and then tile track groups (e.g., as discussed in conjunction with FIG. 12) and/or (b) tile/region patch tracks, together with common component tracks (e.g., as discussed in conjunction with FIG. 11). A track grouping box approach, such as that discussed in FIGS. 11 and 12, can be used for this kind of partition/sub-division/tiling.

Given such partitioning, the inventors have discovered and appreciated a need for signaling regions or viewports in the encoded, partitioned immersive media data. For example, it can be desirable to signal an arbitrary region and the spatial relationship of the region with (e.g., leading) volumetric tracks of its source partitions. The inventors have developed technical improvements to conventional immersive media techniques to signal regions or viewports in immersive media data (e.g., where the region is to be signaled on top of the tile partition). According to some embodiments, an additional track grouping box can be used to signal the relationship of those (e.g., leading) volumetric tracks that contribute to the region. According to some embodiments, a timed metadata track can be used to carry region information and associate itself to those (e.g., leading) volumetric tracks that contribute to the region.

The additional grouping information or timed metadata tracks can be used to send or deliver only tracks that contribute to a particular region. The techniques can be used to improve viewport-dependent point cloud media processing, such that only relevant patch track(s) for a region need to be processed depending on a user's viewport. For example, only the patch track(s) associated with that content and any anticipated movement of the region in space over time can be transmitted to the user's device for decoding and processing. Since prior point cloud content structures encoded the entire point cloud content, such structures did not allow for viewport-based processing of the immersive media content at the track level. Furthermore, the techniques can be used to signal regions of interest and/or recommended viewports from a content producers' point of view, e.g., to guide users to navigate and consume immersive content.

In the following description, numerous specific details are set forth regarding the systems and methods of the disclosed subject matter and the environment in which such systems and methods may operate, etc., in order to provide a thorough understanding of the disclosed subject matter. In addition, it will be understood that the examples provided below are exemplary, and that it is contemplated that there are other systems and methods that are within the scope of the disclosed subject matter.

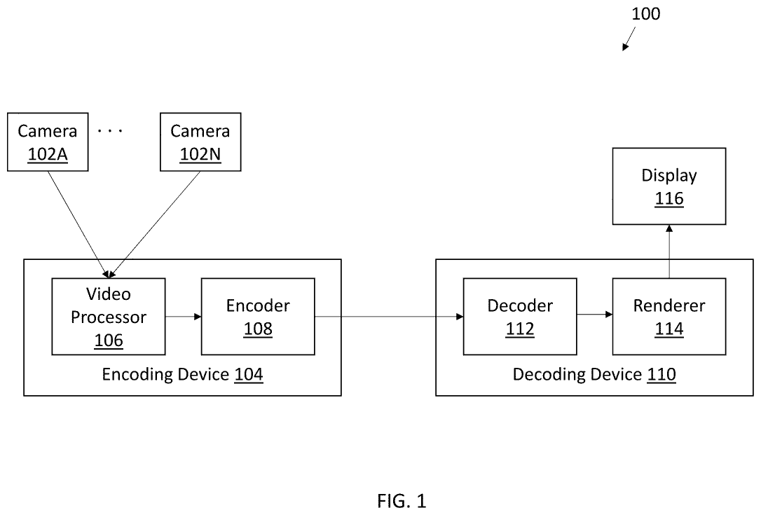

FIG. 1 shows an exemplary video coding configuration 100, according to some embodiments. Cameras 102A-102N are N number of cameras, and can be any type of camera (e.g., cameras that include audio recording capabilities, and/or separate cameras and audio recording functionality). The encoding device 104 includes a video processor 106 and an encoder 108. The video processor 106 processes the video received from the cameras 102A-102N, such as stitching, projection, and/or mapping. The encoder 108 encodes and/or compresses the two-dimensional video data. The decoding device 110 receives the encoded data. The decoding device 110 may receive the video as a video product (e.g., a digital video disc, or other computer readable media), through a broadcast network, through a mobile network (e.g., a cellular network), and/or through the Internet. The decoding device 110 can be, for example, a computer, a portion of a head-worn display, or any other apparatus with decoding capability. The decoding device 110 includes a decoder 112 that is configured to decode the encoded video. The decoding device 110 also includes a renderer 114 for rendering the two-dimensional content back to a format for playback. The display 116 displays the rendered content from the renderer 114.

Generally, 3D content can be represented using spherical content to provide a 360 degree view of a scene (e.g., sometimes referred to as omnidirectional media content). While a number of views can be supported using the 3D sphere, an end user typically just views a portion of the content on the 3D sphere. The bandwidth required to transmit the entire 3D sphere can place heavy burdens on a network, and may not be sufficient to support spherical content. It is therefore desirable to make 3D content delivery more efficient. Viewport dependent processing can be performed to improve 3D content delivery. The 3D spherical content can be divided into regions/tiles/sub-pictures, and only those related to viewing screen (e.g., viewport) can be transmitted and delivered to the end user.

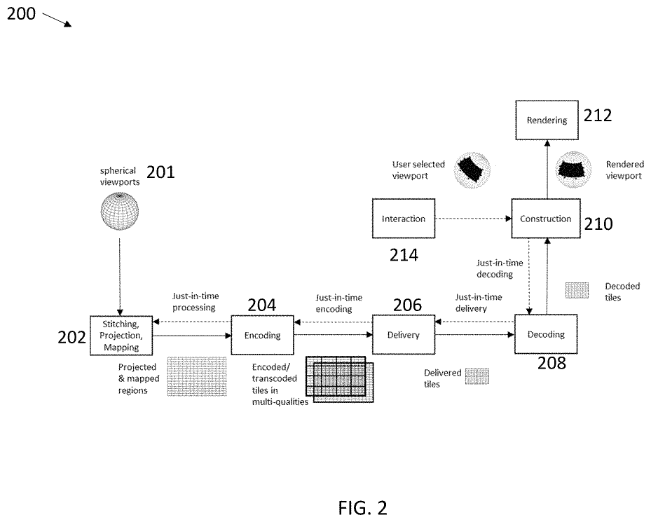

FIG. 2 shows a viewport dependent content flow process 200 for VR content, according to some examples. As shown, spherical viewports 201 (e.g., which could include the entire sphere) undergo stitching, projection, mapping at block 202 (to generate projected and mapped regions), are encoded at block 204 (to generate encoded/transcoded tiles in multiple qualities), are delivered at block 206 (as tiles), are decoded at block 208 (to generate decoded tiles), are constructed at block 210 (to construct a spherical rendered viewport), and are rendered at block 212. User interaction at block 214 can select a viewport, which initiates a number of “just-in-time” process steps as shown via the dotted arrows.

In the process 200, due to current network bandwidth limitations and various adaptation requirements (e.g., on different qualities, codecs and protection schemes), the 3D spherical VR content is first processed (stitched, projected and mapped) onto a 2D plane (by block 202) and then encapsulated in a number of tile-based (or sub-picture-based) and segmented files (at block 204) for delivery and playback. In such a tile-based and segmented file, a spatial tile in the 2D plane (e.g., which represents a spatial portion, usually in a rectangular shape of the 2D plane content) is typically encapsulated as a collection of its variants, such as in different qualities and bitrates, or in different codecs and protection schemes (e.g., different encryption algorithms and modes). In some examples, these variants correspond to representations within adaptation sets in MPEG DASH. In some examples, it is based on user's selection on a viewport that some of these variants of different tiles that, when put together, provide a coverage of the selected viewport, are retrieved by or delivered to the receiver (through delivery block 206), and then decoded (at block 208) to construct and render the desired viewport (at blocks 210 and 212).

As shown in FIG. 2, the viewport notion is what the end-user views, which involves the angle and the size of the region on the sphere. For 360 degree content, generally, the techniques deliver the needed tiles/sub-picture content to the client to cover what the user will view. This process is viewport dependent because the techniques only deliver the content that covers the current viewport of interest, not the entire spherical content. The viewport (e.g., a type of spherical region) can change and is therefore not static. For example, as a user moves their head, then the system needs to fetch neighboring tiles (or sub-pictures) to cover the content of what the user wants to view next.

A region of interest (ROI) is somewhat similar in concept to viewport. An ROI may, for example, represent a region in 3D or 2D encodings of omnidirectional video. An ROI can have different shapes (e.g., a square, or a circle), which can be specified in relation to the 3D or 2D video (e.g., based on location, height, etc.). For example, a region of interest can represent an area in a picture that can be zoomed-in, and corresponding ROI video can be displayed for the zoomed-in video content. In some implementations, the ROI video is already prepared. In such implementations, a region of interest typically has a separate video track that carries the ROI content. Thus, the encoded video specifies the ROI, and how the ROI video is associated with the underlying video. The techniques described herein are described in terms of a region, which can include a viewport, a ROI, and/or other areas of interest in video content.

ROI or viewport tracks can be associated with main video. For example, an ROI can be associated with a main video to facilitate zoom-in and zoom-out operations, where the ROI is used to provide content for a zoom-in region. For example, MPEG-B, Part 10, entitled “Carriage of Timed Metadata Metrics of Media in ISO Base Media File Format,” dated Jun. 2, 2016 (w16191, also ISO/IEC 23001-10:2015), which is hereby incorporated by reference herein in its entirety, describes an ISO Base Media File Format (ISOBMFF) file format that uses a timed metadata track to signal that a main 2D video track has a 2D ROI track. As another example, Dynamic Adaptive Streaming over HTTP (DASH) includes a spatial relationship descriptor to signal the spatial relationship between a main 2D video representation and its associated 2D ROI video representations. ISO/IEC 23009-1, draft third edition (w10225), Jul. 29, 2016, addresses DASH, and is hereby incorporated by reference herein in its entirety. As a further example, the Omnidirectional MediA Format (OMAF) is specified in ISO/IEC 23090-2, which is hereby incorporated by reference herein in its entirety. OMAF specifies the omnidirectional media format for coding, storage, delivery, and rendering of omnidirectional media. OMAF specifies a coordinate system, such that the user's viewing perspective is from the center of a sphere looking outward towards the inside surface of the sphere. OMAF includes extensions to ISOBMFF for omnidirectional media as well as for timed metadata for sphere regions.

When signaling an ROI, various information may be generated, including information related to characteristics of the ROI (e.g., identification, type (e.g., location, shape, size), purpose, quality, rating, etc.). Information may be generated to associate content with an ROI, including with the visual (3D) spherical content, and/or the projected and mapped (2D) frame of the spherical content. An ROI can be characterized by a number of attributes, such as its identification, location within the content it is associated with, and its shape and size (e.g., in relation to the spherical and/or 3D content). Additional attributes like quality and rate ranking of the region can also be added, as discussed further herein.

Point cloud data can include a set of 3D points in a scene. Each point can be specified based on an (x, y, z) position and color information, such as (R,V,B), (Y,U,V), reflectance, transparency, and/or the like. The point cloud points are typically not ordered, and typically do not include relations with other points (e.g., such that each point is specified without reference to other points). Point cloud data can be useful for many applications, such as 3D immersive media experiences that provide 6DoF. However, point cloud information can consume a significant amount of data, which in turn can consume a significant amount of bandwidth if being transferred between devices over network connections. For example, 800,000 points in a scene can consume 1 Gbps, if uncompressed. Therefore, compression is typically needed in order to make point cloud data useful for network-based applications.

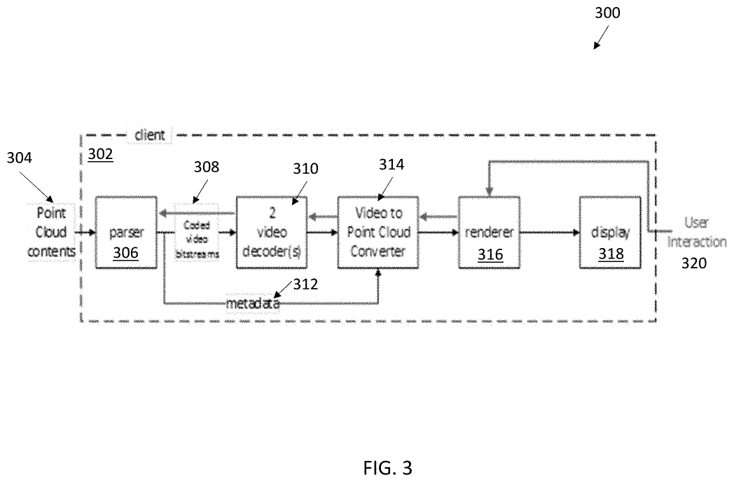

MPEG has been working on point cloud compression to reduce the size of point cloud data, which can enable streaming of point cloud data in real-time for consumption on other devices. FIG. 3 shows an exemplary processing flow 300 for point cloud content as a specific instantiation of the general viewport/ROI (e.g., 3DoF/6DoF) processing model, according to some examples. The processing flow 300 is described in further detail in, for example, N17771, “PCC WD V-PCC (Video-based PCC),” July 2018, Ljubljana, SI, which is hereby incorporated by reference herein in its entirety. The client 302 receives the point cloud media content file 304, which is composed of two 2D planar video bit streams and metadata that specifies a 2D planar video to 3D volumetric video conversion. The content 2D planar video to 3D volumetric video conversion metadata can be located either at the file level as timed metadata track(s) or inside the 2D video bitstream as SEI messages.

The parser module 306 reads the point cloud contents 304. The parser module 306 delivers the two 2D video bitstreams 308 to the 2D video decoder 310. The parser module 306 delivers the 2D planar video to 3D volumetric video conversion metadata 312 to the 2D video to 3D point cloud converter module 314. The parser module 306 at the local client can deliver some data that requires remote rendering (e.g., with more computing power, specialized rendering engine, and/or the like) to a remote rendering module (not shown) for partial rendering. The 2D video decoder module 310 decodes the 2D planar video bitstreams 308 to generate 2D pixel data. The 2D video to 3D point cloud converter module 314 converts the 2D pixel data from the 2D video decoder(s) 310 to 3D point cloud data if necessary using the metadata 312 received from the parser module 306.

The renderer module 316 receives information about users' 6 degree viewport information and determines the portion of the point cloud media to be rendered. If a remote renderer is used, the users' 6DoF viewport information can also be delivered to the remote render module. The renderer module 316 generates point cloud media by using 3D data, or a combination of 3D data and 2D pixel data. If there are partially rendered point cloud media data from a remote renderer module, then the renderer 316 can also combine such data with locally rendered point cloud media to generate the final point cloud video for display on the display 318. User interaction information 320, such as a user's location in 3D space or the direction and viewpoint of the user, can be delivered to the modules involved in processing the point cloud media (e.g., the parser 306, the 2D video decoder(s) 310, and/or the video to point cloud converter 314) to dynamically change the portion of the data for adaptive rendering of content according to the user's interaction information 320.

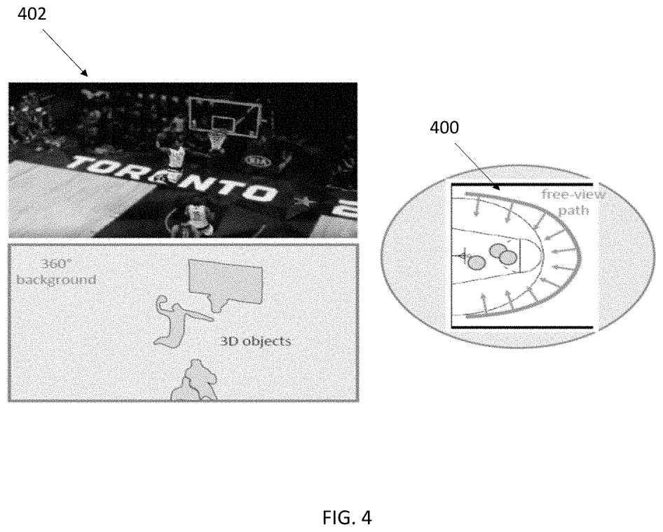

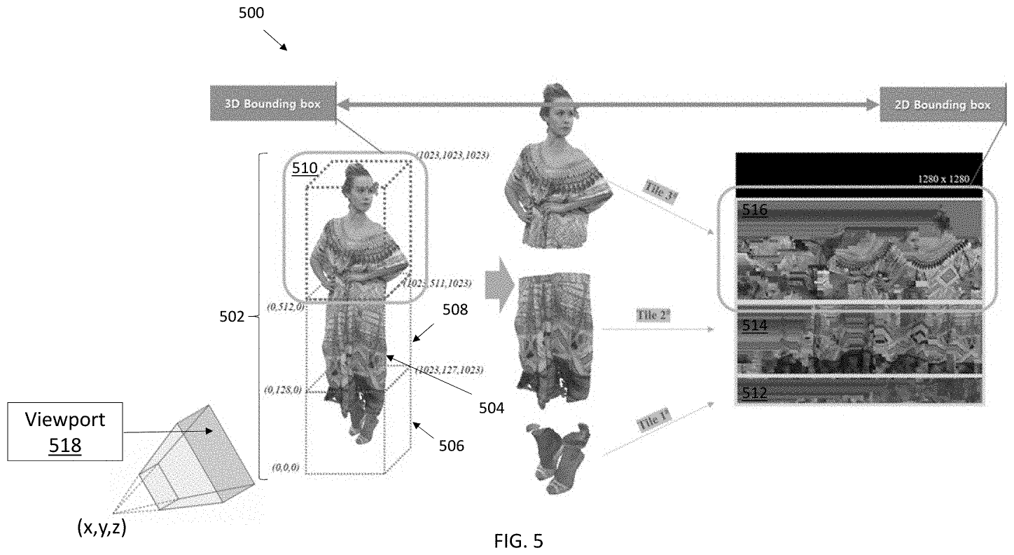

User interaction information for point cloud media needs to be provided in order to achieve such user interaction-based rendering. In particular, the user interaction information 320 needs to be specified and signaled in order for the client 302 to communicate with the render module 316, including to provide information of user-selected viewports. Point cloud content can be presented to the user via editor cuts, or as recommended or guided views or viewports. FIG. 4 shows an example of a free-view path 400, according to some examples. The free-view path 400 allows the user to move about the path to view the scene 402 from different viewpoints.

Viewports, such as recommended viewports (e.g., Video-based Point Cloud Compression (V-PCC) viewports), can be signaled for point cloud content. A point cloud viewport, such as a PCC (e.g., V-PCC or G-PCC (Geometry based Point Cloud Compression)) viewport, can be a region of point cloud content suitable for display and viewing by a user. Depending on a user's viewing device(s), the viewport can be a 2D viewport or a 3D viewport. For example, a viewport can be a 3D spherical region or a 2D planar region in the 3D space, with six degrees of freedom (6DoF). The techniques can leverage 6D spherical coordinates (e.g., ‘6dsc’) and/or 6D Cartesian coordinates (e.g., ‘6dcc’) to provide point cloud viewports. Viewport signaling techniques, including leveraging ‘6dsc’ and ‘6dcc,’ are described in co-owned U.S. patent application Ser. No. 16/738,387, titled “Methods and Apparatus for Signaling Viewports and Regions of Interest for Point Cloud Multimedia Data,” which is hereby incorporated by reference herein in its entirety. The techniques can include the 6D spherical coordinates and/or 6D Cartesian coordinates as timed metadata, such as timed metadata in ISOBMFF. The techniques can use the 6D spherical coordinates and/or 6D Cartesian coordinates to specify 2D point cloud viewports and 3D point cloud viewports, including for V-PCC content stored in ISOBMFF files. The ‘6dsc’ and ‘6dcc’ can be natural extensions to the 2D Cartesian coordinates ‘2dcc’ for planar regions in the 2D space, as provided for in MPEG-B part 10.

In V-PCC, the geometry and texture information of a video-based point cloud is converted to 2D projected frames and then compressed as a set of different video sequences. The video sequences can be of three types: one representing the occupancy map information, a second representing the geometry information and a third representing the texture information of the point cloud data. A geometry track may contain, for example, one or more geometric aspects of the point cloud data, such as shape information, size information, and/or position information of a point cloud. A texture track may contain, for example, one or more texture aspects of the point cloud data, such as color information (e.g., RGB (Red, Green, Blue) information), opacity information, reflectance information and/or albedo information of a point cloud. These tracks can be used for reconstructing the set of 3D points of the point cloud. Additional metadata needed to interpret the geometry and video sequences, such as auxiliary patch information, can also be generated and compressed separately. While examples provided herein are explained in the context of V-PCC, it should be appreciated that such examples are intended for illustrative purposes, and that the techniques described herein are not limited to V-PCC.

V-PCC has yet to finalize a track structure. An exemplary track structure under consideration in the working draft of V-PCC in ISOBMFF is described in N18059, “WD of Storage of V-PCC in ISOBMFF Files,” October 2018, Macau, Conn., which is hereby incorporated by reference herein in its entirety. The track structure can include a track that includes a set of patch streams, where each patch stream is essentially a different view for looking at the 3D content. As an illustrative example, if the 3D point cloud content is thought of as being contained within a 3D cube, then there can be six different patches, with each patch being a view of one side of the 3D cube from the outside of the cube. The track structure also includes a timed metadata track and a set of restricted video scheme tracks for geometry, attribute (e.g., texture), and occupancy map data. The timed metadata track contains V-PCC specified metadata (e.g., parameter sets, auxiliary information, and/or the like). The set of restricted video scheme tracks can include one or more restricted video scheme tracks that contain video-coded elementary streams for geometry data, one or more restricted video scheme tracks that contain video coded elementary streams for texture data, and a restricted video scheme track containing a video-coded elementary stream for occupancy map data. The V-PCC track structure can allow changing and/or selecting different geometry and texture data, together with the timed metadata and the occupancy map data, for variations of viewport content. It can be desirable to include multiple geometry and/or texture tracks for a variety of scenarios. For example, the point cloud may be encoded in both a full quality and one or more reduced qualities, such as for the purpose of adaptive streaming. In such examples, the encoding may result in multiple geometry/texture tracks to capture different samplings of the collection of 3D points of the point cloud. Geometry/texture tracks corresponding to finer samplings can have better qualities than those corresponding to coarser samplings. During a session of streaming the point cloud content, the client can choose to retrieve content among the multiple geometry/texture tracks, in either a static or dynamic manner (e.g., according to client's display device and/or network bandwidth).

A point cloud tile can represent 3D and/or 2D aspects of point cloud data. For example, as described in N18188, entitled “Description of PCC Core Experiment 2.19 on V-PCC tiles, Marrakech, Mass. (January 2019), V-PCC tiles can be used for Video-based PCC. An example of Video-based PCC is described in N18180, entitled “ISO/IEC 23090-5: Study of CD of Video-based Point Cloud Compression (V-PCC),” Marrakech, Mass. (January 2019). Both N18188 and N18180 are hereby incorporated by reference herein in their entirety. A point cloud tile can include bounding regions or boxes to represent the content or portions thereof, including bounding boxes for the 3D content and/or bounding boxes for the 2D content. In some examples, a point cloud tile includes a 3D bounding box, an associated 2D bounding box, and one or more independent coding unit(s) (ICUs) in the 2D bounding box. A 3D bounding box can be, for example, a minimum enclosing box for a given point set in three dimensions. A 3D bounding box can have various 3D shapes, such as the shape of a rectangular parallel-piped that can be represented by two 3-tuples (e.g., the origin and the length of each edge in three dimensions). A 2D bounding box can be, for example, a minimum enclosing box (e.g., in a given video frame) corresponding to the 3D bounding box (e.g., in 3D space). A 2D bounding box can have various 2D shapes, such as the shape of a rectangle that can be represented by two 2-tuples (e.g., the origin and the length of each edge in two dimensions). There can be one or more ICUs (e.g., video tiles) in a 2D bounding box of a video frame. The independent coding units can be encoded and/or decoded without the dependency of neighboring coding units.

FIG. 5 is a diagram showing exemplary point cloud tiles, including 3D and 2D bounding boxes, according to some examples. Point cloud content typically only includes a single 3D bounding box around the 3D content, shown in FIG. 5 as the large box 502 surrounding the 3D point cloud content 504. As described above, a point cloud tile can include a 3D bounding box, an associated 2D bounding box, and one or more independent coding unit(s) (ICUs) in the 2D bounding box. To support viewport dependent processing, the 3D point cloud content typically needs to be subdivided into smaller pieces or tiles. FIG. 5 shows, for example, the 3D bounding box 502 can be divided into smaller 3D bounding boxes 506, 508 and 510, which each have an associated 2D bounding box 512, 514 and 516, respectively.

As described herein, some embodiments of the techniques can include, for example, sub-dividing the tiles (e.g., sub-dividing 3D/2D bounding boxes) into smaller units to form desired ICUs for V-PCC content. The techniques can encapsulate the sub-divided 3D volumetric regions and 2D pictures into tracks, such as into ISOBMFF visual (e.g., sub-volumetric and sub-picture) tracks. For example, the content of each bounding box can be stored into an associated sets of tracks, where each of the sets of tracks stores the content of one of the sub-divided 3D sub-volumetric regions and/or 2D sub-pictures. For the 3D sub-volumetric case, such a set of tracks include tracks that store geometry, attribute and texture attributes. For the 2D sub-picture case, such a set of tracks may just contain a single track that stores the sub-picture content. The techniques can provide for signaling relationships among the sets of tracks, such as signaling the respective 3D/2D spatial relationships of the sets of tracks using track groups and/or sample groups of ‘3dcc’ and ‘2dcc’ types. The techniques can signal the tracks associated with a particular bounding box, a particular sub-volumetric region or a particular sub-picture, and/or can signal relationships among the sets of tracks of different bounding boxes, sub-volumetric regions and sub-pictures. Providing point cloud content in separate tracks can facilitate advanced media processing not otherwise available for point cloud content, such as point cloud tiling (e.g., V-PCC tiling) and viewport-dependent media processing.

In some embodiments, the techniques provide for dividing the point cloud bounding boxes into sub-units. For example, the 3D and 2D bounding boxes can be sub-divided into 3D sub-volumetric boxes and 2D sub-picture regions, respectively. The sub-regions can provide ICUs that are sufficient for track-based rendering techniques. For example, the sub-regions can provide ICUs that are fine enough from a systems point of view for delivery and rendering in order to support the viewport dependent media processing. In some embodiments, the techniques can support viewport dependent media processing for V-PCC media content, e.g., as provided in m46208, entitled “Timed Metadata for (Recommended) Viewports of V-PCC Content in ISOBMFF,” Marrakech, Mass. (January 2019), which his hereby incorporated by reference herein in its entirety. As described further herein, each of the sub-divided 3D sub-volumetric boxes and 2D sub-picture regions can be stored in tracks in a similar manner as if they are (e.g., un-sub-divided) 3D boxes and 2D pictures, respectively, but with smaller sizes in terms of their dimensions. For example, in the 3D case, a sub-divided 3D sub-volumetric box/region will be stored in a set of tracks comprising geometry, texture and attribute tracks. As another example, in the 2D case, a sub-divided sub-picture region will be stored in a single (sub-picture) track. As a result of sub-dividing the content into smaller sub-volumes and sub-pictures, the ICUs can be carried in various ways. For example, in some embodiments different sets of tracks can be used to carry different sub-volumes or sub-pictures, such that the tracks carrying the sub-divided content have less data compared to when storing all of the un-sub-divided content. As another example, in some embodiments some and/or all of the data (e.g., even when subdivided) can be stored in the same tracks, but with smaller units for the sub-divided data and/or ICUs (e.g., so that the ICUs can be individually accessed in the overall set of track(s)).

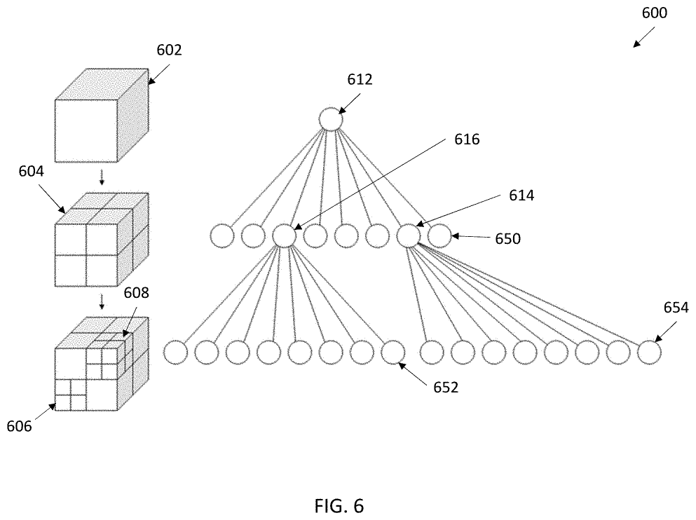

Various types of division can be used to provide the sub-units or ICUs, including 3D and 2D divisions. FIG. 6 is a diagram 600 showing an exemplary octree-based division for 3D sub-volumetric decomposition, according to some embodiments. As shown on the left, a 3D bounding box 602 can be divided into eight sub-regions 604, which can be further sub-divided as shown for sub-regions 606 and 608. In some embodiments, the system can determine how to divide and further sub-divided the point cloud content based on various parameters, such as the ROIs associated with the point cloud content, an amount of detail that is supported for a particular side, and/or the like. Referring to the tree structure, each interior node (e.g., nodes 612, 614 and 616) in the tree represents a 3D source, which is divided into a plurality of regions such that each sub-node represents the sub-volumetric tracks. As described further herein, a track group (e.g., a ‘3dcc’ track group) can be used to represent the sub-volumetric tracks.

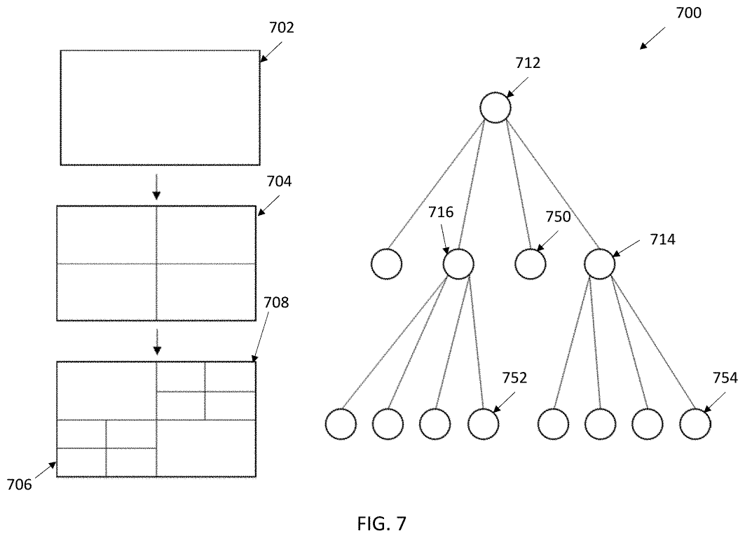

FIG. 7 is a diagram 700 showing an exemplary quadtree-based division for 2D sub-picture decomposition, according to some embodiments. As shown on the left, a 2D bounding box 702 can be divided into four sub-regions 704, which can be further sub-divided as shown for sub-regions 706 and 708. Each interior node (e.g., nodes 712, 714 and 716) in the tree represents a 2D source, which is divided into a plurality of regions such that each sub-node represents the sub-picture tracks. As described further herein, a track group (e.g., a ‘2dcc’ track group) can be used to represent the sub-picture tracks.

The subdivided 2D and 3D regions may be of various shapes, such as squares, cubes, rectangles, and/or arbitrary shapes. The division along each dimension may not be binary. Therefore, each division tree of an outer-most 2D/3D bounding box can be much more general than the quadtree and octree examples provided herein. It should therefore be appreciated that various shapes and subdivision strategies can be used to determine each leaf region in the division tree, which represents an ICU (in the 2D or 3D space or bounding box). As described herein, the ICUs can be configured such that for end-to-end media systems the ICUs support viewport dependent processing (including delivery and rendering). For example, the ICUs can be configured according to m46208, where a minimal number of ICUs can be spatially randomly accessible for covering a viewport that is potentially dynamically moving (e.g., for instance, controlled by the user on a viewing device or based on a recommendation from the editor).

The point cloud ICUs can be carried in associated, separate tracks. In some embodiments, the ICUs and division trees can be carried and/or encapsulated in respective sub-volumetric and sub-picture tracks and track groups. The spatial relationship and sample groups of the sub-volumetric and sub-picture tracks and track groups can be signaled in, for example, ISOBMFF as described in ISO/IEC 14496-12.

Some embodiments can leverage, for the 2D case, the generic sub-picture track grouping extensions with the track grouping type ‘2dcc’ as provided in OMAF, e.g., as provided in Section 7.1.11 of the working draft of OMAF, 2nd Edition, N18227, entitled “WD 4 of ISO/IEC 23090-2 OMAF 2nd edition,” Marrakech, Mass. (January 2019), which is hereby incorporated by reference herein in its entirety. Some embodiments can update and extend, for the 3D case, the generic sub-volumetric track grouping extension with a new track grouping type ‘3dcc’. Such 3D and 2D track grouping mechanisms, can be used to group the example (leaf node) sub-volumetric tracks in the octree decomposition and sub-picture tracks in the quadtree decomposition into three ‘3dcc’ and ‘2dcc’ track groups, respectively.

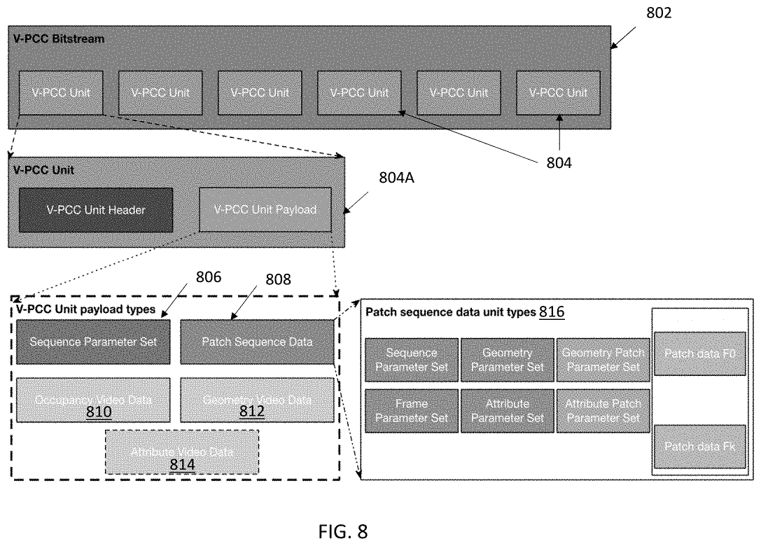

A point cloud bit stream can include a set of units that carry the point cloud content. The units can allow, for example, random access to the point cloud content (e.g., for ad insertion and/or other time-based media processing). For example, V-PCC can include a set of V-PCC Units, as described in N18180, “ISO/IEC 23090-5: Study of CD of Video-based Point Cloud Compression (V-PCC),” Marrakech, Mass. January 2019, which is hereby incorporated by reference herein in its entirety. FIG. 8 shows a V-PCC bitstream 802 that is composed of a set of V-PCC units 804, according to some examples. Each V-PCC unit 804 has a V-PCC unit header and a V-PCC unit payload, as shown for V-PCC unit 804A, which includes V-PCC unit header and a V-PCC unit payload. The V-PCC unit header describes the V-PCC unit type. The V-PCC unit payload can include a sequence parameter set 806, patch sequence data 808, occupancy video data 810, geometry video data 812, and attribute video data 814. The patch sequence data unit 808 can include one or more patch sequence data unit types 816 as shown (e.g., sequence parameter set, frame parameter set, geometry parameter set, attribute parameter set, geometry patch parameter set, attribute patch parameter set, and/or patch data, in this non-limiting example).

In some examples, the occupancy, geometry, and attribute Video Data unit payloads 810, 812 and 814, respectively, correspond to video data units that could be decoded by the video decoder specified in the corresponding occupancy, geometry, and attribute parameter set V-PCC units. Referring to the patch sequence data unit types, V-PCC considers an entire 3D bounding box (e.g., 502 in FIG. 5) to be a cube, and considers projection onto one surface of the cube to be a patch (e.g., such that there can be six patches for each side). Therefore, the patch information can be used to indicate how the patches are encoded and relate to each other.

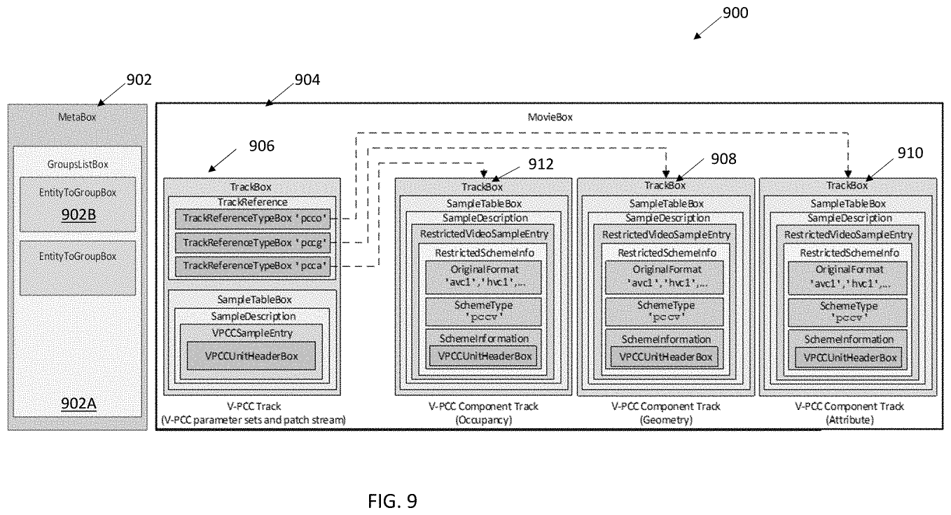

FIG. 9 shows an ISOBMFF-based V-PCC container 900, according to some examples. The container 900 can be, for example, as documented in the latest WD of Carriage of Point Cloud Data N18266m “WD of ISO/IEC 23090-10 Carriage of PC data,” Marrakech, Mass. January 2019, which is hereby incorporated by reference herein in its entirety. As shown, the V-PCC container 900 includes a metadata box 902 and a movie box 904 that includes a V-PCC parameter track 906, a geometry track 908, an attribute track 910, and an occupancy track 912. Therefore, the movie box 904 includes the general tracks (e.g., geometry, attribute, and occupancy tracks), and a separate metadata box track 902 includes the parameters and grouping information.

As an illustrative example, each EntityToGroupBox 902B in the GroupListBox 902A of the Metabox 902 contains a list of references to entities, which in this example include a list of references to the V-PCC parameter track 906, the geometry track 908, the attribute track 910, and the occupancy track 912. A device uses those referenced tracks to collectively re-construct a version of the underlying point cloud content (e.g., with a certain quality).

Various structures can be used to carry point cloud content. For example, as described in N18479, entitled “Continuous Improvement of Study Test of ISO/IEC CD 23090-5 Video-based Point Cloud Compression”, Geneva, CH (March 2019), which is hereby incorporated by reference herein in its entirety, the V-PCC bitstream may be composed of a set of V-PCC units as shown in FIG. 8. In some embodiments, each V-PCC unit may have a V-PCC unit header and a V-PCC unit payload. The V-PCC unit header describes the V-PCC unit type.

As described herein, the occupancy, geometry, and attribute Video Data unit payloads correspond to video data units that could be decoded by the video decoder specified in the corresponding occupancy, geometry, and attribute parameter set V-PCC units. As described in N18485, entitled “V-PCC CE 2.19 on tiles”, Geneva, CH (March 2019), which is hereby incorporated by reference herein in its entirety, the Core Experiment (CE) may be used to investigate the V-PCC tiles for Video-based PCC as specified in N18479, for meeting the requirements of parallel encoding and decoding, spatial random access, and ROI-based patch packing.

A V-PCC tile may be a 3D bounding box, a 2D bounding box, one or more Independent coding unit(s) (ICUs), and/or an equivalent structure. For example, this is described in conjunction with exemplary FIG. 5 and described in m46207, entitled “Track Derivation for Storage of V-PCC Content in ISOBMFF,” Marrakech, Mass. (January 2019), which is hereby incorporated by reference herein in its entirety. In some embodiments, the 3D bounding box may be a minimum enclosing box for a given point set in 3 dimensions. A 3D bounding box with the shape of a rectangular parallel-piped can be represented by two 3-tuples. As an example, the two 3-tuples may include the origin and the length of each edge in three dimensions. In some embodiments, the 2D bounding box may be a minimum enclosing box (e.g. in a given video frame) corresponding to the 3D bounding box (e.g. in 3D space). A 2D bounding box with the shape of a rectangle can be represented by two 2-tuples. For example, the two 2-tuples may include the origin and the length of each edge in two dimensions. In some embodiments, there can be one or more independent coding units (ICUs), (e.g., video tiles) in a 2D bounding box of a video frame. The independent coding units may be encoded and decoded without the dependency of neighboring coding units.

In some embodiments, the 3D and 2D bounding boxes may be subdivided into 3D sub-volumetric regions and 2D sub-pictures, respectively, (e.g. as provided in m46207, “Track Derivation for Storage of V-PCC Content in ISOBMFF,” Marrakech, Mass. (January 2019) and m47355, “On Track Derivation Approach to Storage of Tiled V-PCC Content in ISOBMFF,” Geneva, CH. (March 2019), which are hereby incorporated by reference herein in their entirety) so that they become needed ICUs that are fine enough also from the Systems point of view for delivery and rendering in order to support the viewport dependent media processing for V-PCC media content as described in m46208.

As described above, FIG. 6 shows an example of an octree-based division of a 3D sub-volumetric decomposition, and FIG. 7 shows an example of a quadtree-based division of a 2D sub-picture decomposition.

Quadtrees can be considered the 2D analog of 3D octrees and are most often used to partition 2D and 3D spaces by recursively subdividing them into four quadrants and eight octants or regions.

For the purpose of tiling V-PCC media content, the subdivided 2D pictures and 3D regions may be square-shaped, cube-shaped, rectangular-shaped, and/or may have arbitrary shapes. Furthermore, the division along each dimension may not necessarily be binary. Thus, each division tree of an out-most 2D/3D bounding box can be much more general than quadtree and/or octree. Regardless of the shape, from the end-to-end media system point of view, each leaf sub-picture or region in the division tree may represent an ICU (e.g., within the 2D or 3D bounding box), for supporting viewport dependent processing, which may include delivery and rendering, as described in m46208), where a minimal number of ICUs can be spatially random accessible for covering a viewport that is potentially dynamically moving, for instance, controlled by the user on a viewing device or based on a recommendation from the editor.

Various deficiencies can exist when using conventional point cloud container techniques. For example, taking the above consideration of tiling V-PCC media content, the structure for an ISOBMFF-based V-PCC container (e.g., as shown in FIG. 9 and/or the V-PCC container described in N18413, entitled “WD of ISO/IEC 23090-10 Carriage of PC data,” Geneva, CH (March 2019), which is hereby incorporated by reference herein in its entirety) becomes inadequate. For example, each of the leaf nodes for the sub-divided 2D sub-pictures and 3D sub-regions of a conventional ISOBMFF-based V-PCC container needs to be carried as a valid elementary V-PCC media track, and each of the non-leaf nodes need to be carried as a valid composite V-PCC media track as well.

It can be desirable to provide techniques for encoding and/or decoding point cloud video data using separate patch tracks that each encode an associated different portion of the point cloud content in a single immersive media structure. The techniques described herein provide for a point cloud content structure that leverages separate patch tracks to break up and encode the original immersive media content (e.g., which can include 2D and/or 3D point cloud content) such that multiple patch tracks can be included in the immersive media structure and can share one or more common elementary data tracks (e.g., including one or more geometry, attribute, and/or occupancy tracks).

In some embodiments, a patch track-based container structure (e.g., an ISOBMFF V-PCC container structure) can be used to store V-PCC media content. The patch track based container structure can specify separate V-PCC patch tracks that encode data for different portions of the point cloud content while sharing some and/or all of the same elementary data tracks (e.g., including one or more geometry, attribute, and/or occupancy tracks). The patch track-based container structure can, for example, be used as an alternative to derived track based structures, such as those described in m46207 and m47355. In some embodiments, 2D/3D spatial grouping mechanisms of patch tracks can be used when V-PCC media content is sub-divided at either V-PCC level or systems level, such as by using 2D sub-picture and 3D sub-region grouping mechanisms. For example, the techniques can use the 2D sub-picture and 3D sub-region grouping mechanisms described in m47335, entitled “Signaling of 2D and 3D spatial relationship and sample groups for V-PCC Sub-Volumetric Tracks in ISOBMFF,” Geneva, CH, (March 2019), which is hereby incorporated by reference herein in its entirety.

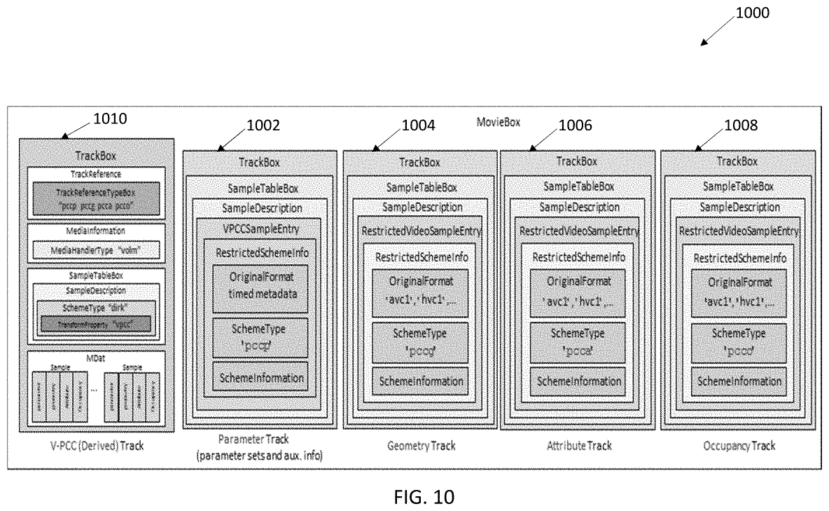

According to some embodiments, point cloud container structures, such as the patch track based ISOBMFF container structure, can be used to store V-PCC media content. According to some embodiments, track groups and sample groups (e.g., of the ‘2dcc’ and ‘3dcc’ types) may be used for signaling of 3D/2D spatial relationships of patch tracks for V-PCC tiles (or sub-divisions). For example, the track groups disclosed in m47335 can be used to signal the 2D/3D spatial relationships of the V-PCC content. FIG. 10 is an exemplary diagram of a container structure 1000 for patch track-based storage of V-PCC content in ISOBMFF, according to some embodiments. The diagram 1000 is based on the V-PCC bit stream structure (e.g. as provided in N18485). In this ISOBMFF container structure 1000, V-PCC Component Data Units may be stored in their respective tracks (e.g., as described in N18413), without requiring the parameter (metadata) track having to make references to the other tracks. As shown in this example, the other tracks in the container structure 100 may include a parameter track 1002 which can contain V-PCC specified timed metadata (for example, parameter sets and/or auxiliary information), one or more geometry video tracks 1004 containing video-coded elementary streams for geometry data, one or more attribute video tracks 1006 containing video coded elementary streams for attribute data, an occupancy map video track 1008 containing a video-coded elementary stream for occupancy map data, and/or the like. A V-PCC media track can be encoded as a single patch track with the new media (handler) type ‘volm’, for volumetric content, which may serve as the entry point for the V-PCC content. This track may make references to the component tracks which may include the parameter track, geometry video track, attribute track, occupancy video track, and/or the like.

According to some embodiments, the V-PCC media content can be tiled. V-PCC tiling or sub-division methods include patch-level partitioning, 3D grid division, and/or the like. With respect to the patch track based ISOBMFF V-PCC container structure, these methods correspond to a single container with multiple patch tracks and multiple containers of a single patch track.

In some embodiments, V-PCC tiling can be done using the patch-level partitioning method, wherein multiple tile patch tracks may be created within a single container, whereas the other component tracks (e.g., parameter, geometry, attribute and/or occupancy tracks) remain intact. FIG. 11 is an exemplary diagram of V-PCC patch-level partitioning, according to some embodiments. A number of tile patches, including 1101, 1102 and 1103 as examples, may be created within a single container 1100 according to the patch-level partitioning method. Each of the tile patch tracks can relate to associated partitioned V-PCC content. V-PCC content such as a V-PCC tile may be a 3D bounding box, a 2D bounding box and/or one or more ICU(s) as described herein and as can be seen in exemplary diagram FIG. 5.

In some embodiments, V-PCC tiling can be done using the 3D grid division method, wherein each 3D tile can be considered at the Systems level as a valid V-PCC media content by itself, and therefore encapsulated in a single ISOBMFF container. Hence, such techniques can result in multiple containers of a patch track together with the other component tracks. FIG. 12 is an exemplary diagram showing individual V-PCC tracks 1202, 1204, and 1206 (e.g. from FIG. 11) as each being associated with the component tracks including, for example, parameter 1208, geometry 1210, attribute 1212 and/or occupancy 1214 tracks, according to some embodiments of the present invention. It should be understood that while FIG. 12 appears to show multiple sets of the same component tracks (e.g. parameter 1208, geometry 1210, attribute 1212 and/or occupancy tracks 1214) for each tile, FIG. 12 exists solely for illustrative purposes to show that at the systems level each tile can be considered to be a valid V-PCC media content by itself. The track structure should include only one set of the component tracks as shown in FIG. 11.

According to some embodiments, the techniques relate to spatial grouping of tiled patch tracks of V-PCC media content. In some examples, 2D and 3D spatial relationships and/or sample groups can be used for spatial grouping. For example, 2D and 3D spatial relationship and sample groups for V-PCC sub-volumetric tracks can be signaled, such the techniques described in m47335 for ISOBMFF. For example, in the 2D case, the “generic sub-picture track grouping extensions” with the track grouping type ‘2dcc’ (e.g., described in Section 7.1.11 of N18227) can be used for 2D tiles. As another example, for the 3D case, the “generic sub-volumetric track grouping extension” with the track grouping type ‘3dcc’ can be used for 3D tiles.

FIG. 11 shows an example of the spatial grouping technique discussed herein. The track group 1105 is shown to contain another track group, 1106. Tile patches in different groups, including 1101, 1102 and 1103 as examples, may be created within a single container 1100 as is shown. The spatial grouping of V-PCC grid tiles can be realized by the spatial grouping of the corresponding tile tracks (i.e. by placing the corresponding 3D grouping boxes of type ‘3dcc’, and/or the corresponding 2D grouping boxes of type ‘2dcc’ within the tile tracks). Track groups 1216 and 1218 of FIG. 12 show individual V-PCC tracks 1202, 1204, and 1206 belonging to one or more track groups (e.g. from FIG. 11) as each being associated with the component tracks including, for example, parameter 1208, geometry 1210, attribute 1212 and/or occupancy 1214 tracks.

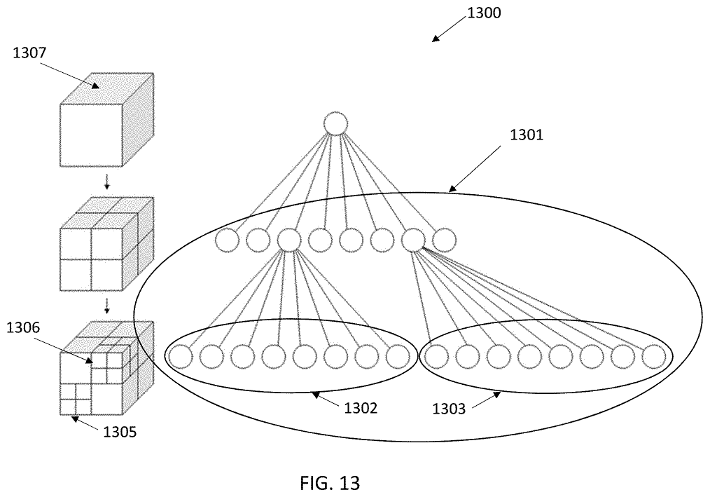

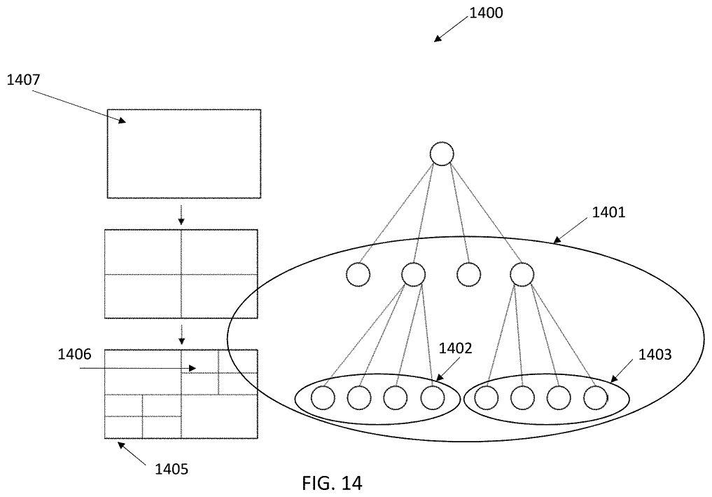

FIG. 13 is an exemplary diagram showing three ‘3dcc’ track groups of sub-volumetric (leaf-node) tracks based on the exemplary octree-based division for 3D sub-volumetric decomposition shown in FIG. 6, according to some embodiments. Referring to FIG. 13, for example, the three ‘3dcc’ track groups include 1301, containing both non-leaf composite tracks and leaf tracks, and track groups 1302 and 1303, both containing leaf tracks. Tracks within a group can be seen as belonging to a part of the same spatial portion. For example, the tracks in group 1302 each provide an associated portion of the spatial portion 1305, and the tracks in group 1303 each provide an associated portion of the spatial portion 1306. Track groups may comprise one or more other groups, for example as shown in FIG. 13 and FIG. 14 (e.g. group 1302 and 1303 are contained in 1301 in FIG. 13, group 1402 and 1403 are contained in 1401 in FIG. 14). According to some embodiments, the ‘3dcc’ track groups may comprise other groups such that if a first group (e.g. 1301) contains a second group (e.g. 1302, 1303), the spatial portion of immersive media content corresponding to the first group (e.g. 1301) contains the spatial portion of immersive media content corresponding to the second group (e.g. 1302, 1303). The spatial portion of immersive media content corresponding to the patch track belonging to the second group (e.g. 1302, 1303) may therefore be of lesser volume than the spatial portion of immersive media content corresponding to the patch track of the first group (e.g. 1301). For example, the leaf tracks of 1302 and 1303, which each specify smaller spatial portions 1305 and 1306, respectively, specify spatial portions of the larger the spatial portion 1307 specified by track group 1301.

FIG. 14 is an exemplary diagram showing three ‘2dcc’ track groups of sub-volumetric (leaf-node) tracks based on the exemplary quadtree-based division for 2D sub-picture decomposition shown in FIG. 7, according to some embodiments. For example, FIG. 14 shows three ‘2dcc’ track groups including 1401, containing non-leaf composite tracks and leaf tracks, and including track groups 1402 and 1403, both containing leaf tracks. Tracks within the same group can be seen as belonging to a part of the same spatial portion. For example, the tracks in group 1402 each provide an associated portion of the spatial portion 1405, and the tracks in group 1403 each provide an associated portion of the spatial portion 1406. According to some embodiments, the ‘2dcc’ track groups may comprise other groups such that if a first group (e.g. 1401) contains a second group (e.g. 1402, 1403), the spatial portion of immersive media content corresponding to the first group (e.g. 1401) contains the spatial portion of immersive media content corresponding to the second group (e.g. 1402, 1403). The spatial portion of immersive media content corresponding to the patch track belonging to the second group (e.g. 1402, 1403) may therefore be of lesser size than the spatial portion of immersive media content corresponding to the patch track of the first group (e.g. 1401). For example, the leaf tracks of 1402 and 1403, which each specify smaller spatial portions 1405 and 1406, respectively, specify spatial portions of the larger the spatial portion 1407 specified by track group 1401. With the 3D and 2D track grouping mechanisms, the example (leaf node) sub-volumetric tracks, 1300 and 1400, in the octree decomposition and sub-picture tracks in the quadtree decomposition can be illustratively grouped into multiple (3 in each of the examples) ‘3dcc’ and ‘2dcc’ track groups, as can be seen in illustrative FIG. 13 and FIG. 14. According to some embodiments, when point cloud media content is stored according to the techniques described herein (e.g., when V-PCC media content is stored in the patch track based ISOBMFF container described herein). In some embodiments, when point cloud media is tiled using the methods discussed below, spatial grouping of V-PCC tiles can be realized by the spatial grouping of the corresponding tile patch tracks, that is, by placing the corresponding 2D/3D grouping boxes of type ‘2dcc’ and ‘3dcc’ within the tile patch tracks.

In some embodiments, the techniques relate to patch-level partitioning. For example, V-PCC tiling can be done using patch-level partitioning techniques described herein. For example, multiple tile patch tracks can be created within a single container, whereas the other component tracks may remain intact, as described herein. The spatial relationship of these tile patch tracks, which can be at multiple levels depending on the number of levels of tiling (or sub-division), can be signaled by their containing 2D/3D grouping boxes (e.g., of type ‘2dcc’ and type ‘3dcc’).

In some embodiments, the techniques relate to 3D grid division. For example, V-PCC tiling can be done using the 3D grid division techniques described herein. For example, each 3D tile can be considered at the Systems level as valid V-PCC media content by itself, and therefore may be encapsulated in a single ISOBMFF container. Hence, the techniques can result in multiple containers of a patch track together with the other component tracks. The spatial relationship of these tile patch tracks may be in their containers, which can be at multiple levels depending on the number of levels of tiling or sub-division, can be signaled by their containing 2D/3D grouping boxes (e.g., of type ‘2dcc’ and type ‘3dcc’).

A V-PCC tile may be a 3D bounding box, a 2D bounding box, one or more Independent coding unit(s) (ICUs), and/or an equivalent structure, where some embodiments of these structures are discussed herein. As described herein, point cloud content within a V-PCC Tile may correspond to a V-PCC bit-stream or one of potentially multiple patch data groups (e.g. as described in V-PCC Systems Adhoc meeting held on Jun. 13-14, 2019). This is demonstrated in FIG. 8, for example, which illustrates an example of V-PCC Bit-stream Structure.

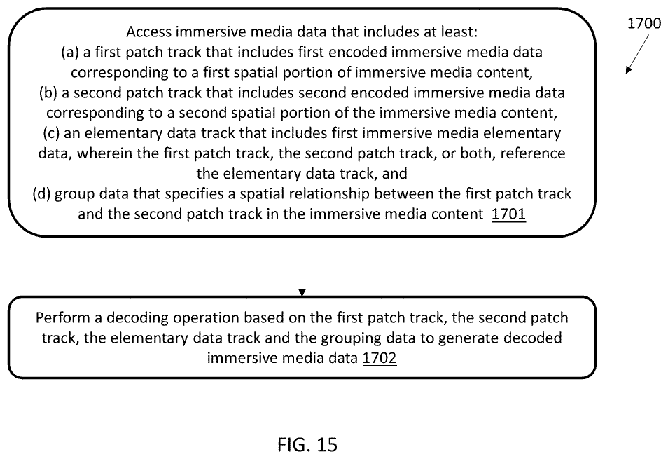

FIG. 15 shows an exemplary method 1700 for decoding video data for immersive data, according to some embodiments. The method comprises accessing and/or receiving immersive media data at step 1701 that includes a plurality of patch tracks, including (a) at least a first patch track that includes encoded immersive media data that corresponds to a first spatial portion of immersive media content, and (b) a second patch track that includes encoded immersive media data corresponding to a second spatial portion of the immersive media content. The immersive media data also includes (c) an elementary data track that includes immersive media elementary data. As described herein, for example, the elementary data track can be a parameter track, geometry track, texture track, and/or occupancy track. The first patch track, the second patch track, or both, reference the elementary data track. The immersive media data also includes (d) group data that specifies a spatial relationship between the first patch track and the second patch track in the immersive media content.

At step 1702, the method includes performing a decoding operation based on the first patch track, the second patch track, the elementary data track and the grouping data to generate decoded immersive media data. The immersive media content can be point cloud multimedia.

According to some embodiments, a patch track, (e.g. the first and second patch track of FIG. 15), contains an associated portion of grouping data that indicates that the patch group is part of one or more groups of patch tracks. When there is more than one group, a group can in some cases include one or more other groups, for example as shown in FIG. 13 and FIG. 14 (e.g. group 1302 and 1303 are contained in 1301 in FIG. 13, group 1402 and 1403 are contained in 1401 in FIG. 14). When there is more than one group, such that a first group contains a second group, the spatial portion of immersive media content corresponding to the first group contains the spatial portion of immersive media content corresponding to the second group.

Accessing the immersive media data as in step 1701 of exemplary method 1700 includes accessing the geometry data in one or more geometry tracks, the attribute data in one or more attribute tracks, and/or the occupancy map data of the occupancy track. Performing the immersive media track derivation operation in 1702 includes performing the immersive media track derivation operation on the geometry data, the attribute data, and the occupancy map data, to generate the decoded immersive media data. The immersive media data can be encoded two-dimensional (2D) data and/or encoded three-dimensional (3D) data.

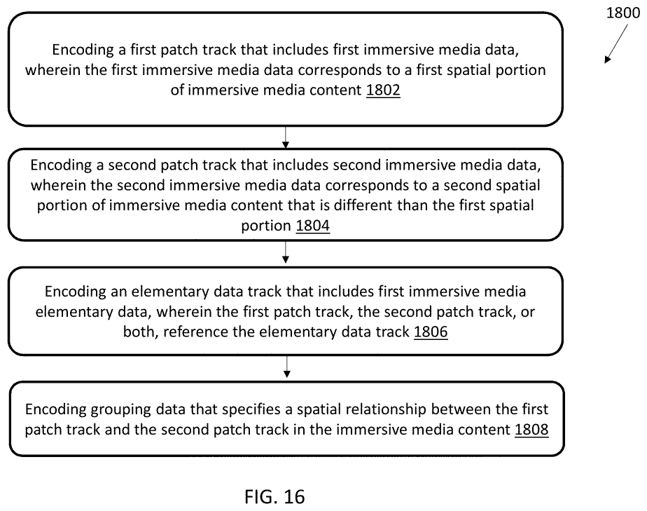

As discussed herein, the techniques can be similarly used to encode video content. For example, FIG. 16 shows an exemplary method 1800 for encoding video data for immersive data, according to some embodiments. The method includes step 1802 in which a first patch track is encoded, and step 1804 in which a second patch track is encoded, where the first and second patch track each include immersive media data that corresponds to a first and second spatial portion of immersive media content respectively and step 1806 corresponding to encoding an elementary data track that includes immersive media elementary data. The first patch track, the second patch track, or both, reference the elementary data track. The method further includes step 1808, in which grouping data is encoded.

Metadata structures may be used to specify information about sources, regions and their spatial relations, such as by using timed metadata tracks and/or track grouping boxes of ISOBMFF. The inventors have recognized that in order to deliver point cloud content more efficiently, including in live and/or on-demand streaming scenarios, mechanisms like DASH (such as described in “Media presentation description and segment formats,” 3rd Edition, September 2018, which is hereby incorporated by reference herein in its entirety) can be used for encapsulating and signaling about sources, regions, their spatial relations, and/or viewports.

The inventors have recognized the need to provide additional mechanisms for dealing with point cloud content, such as for 3D media content in DASH. According to some embodiments, for example, a viewport may be specified using one or more structures. In some embodiments, a viewport may be specified as described in the Working Draft of MIV, entitled “Working Draft 2 of Metadata for Immersive Video,” dated July 2019 (N18576) which is hereby incorporated by reference herein in its entirety. In some embodiments, a viewing orientation may include a triple of azimuth, elevation, and tilt angle that may characterize the orientation that a user is consuming the audio-visual content; in case of image or video, it may characterize the orientation of the viewport. In some embodiments, a viewing position may include a triple of x, y, z characterizing the position in the global reference coordinate system of a user who is consuming the audio-visual content; in case of image or video, characterizing the position of the viewport. In some embodiments, a viewport may include a projection of texture onto a planar surface of a field of view of an omnidirectional or 3D image or video suitable for display and viewing by the user with a particular viewing orientation and viewing position.

In order to specify spatial relationships of 2D/3D regions within their respective 2D and 3D sources, some metadata data structures may be specified according to some embodiments described herein, including 2D and 3D spatial source metadata data structures and region and viewport metadata data structures.

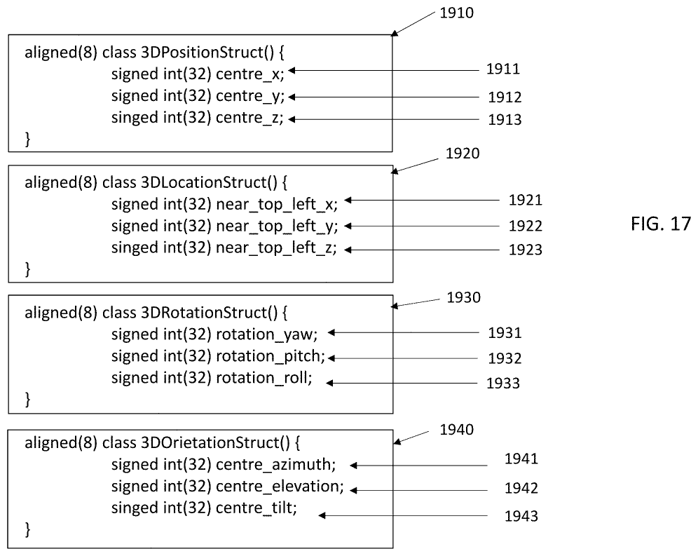

FIG. 17 is an exemplary diagram showing metadata data structures for 3D elements, according to some embodiments. The centre_x field 1911, centre_y field 1912 and centre_z field 1913 of exemplary 3D position metadata data structure 1910 in FIG. 17 may specify the x, y and z axis values, respectively, of the centre of the sphere region, for example, with respect to the origin of the underlying coordinate system. The near_top_left_x field 1921, near_top_left_y field 1922, and near_top_left_z field 1923 of exemplary 3D location metadata data structure 1920 may specify the x, y, and z axis values, respectively, of the near-top-left corner of the 3D rectangular region, for example, with respect to the origin of the underlying 3D coordinate system.

The rotation_yaw field 1931, rotation_pitch field 1932, and rotation_roll field 1933 of exemplary 3D rotation metadata data structure 1930 may specify the yaw, pitch, and roll angles, respectively, of the rotation that is applied to the unit sphere of each spherical region associated in the spatial relationship to convert the local coordinate axes of the spherical region to the global coordinate axes, which may be in units of 2⁻¹⁶ degrees, relative to the global coordinate axes. In some examples, the rotation_yaw field 1931 may be in the range of −180*2¹⁶ to 180*2¹⁶−1, inclusive. In some examples, the rotation pitch field 1932 may be in the range of −90*2¹⁶ to 90* 2¹⁶, inclusive. In some examples, the rotation roll field 1933 shall be in the range of −180*2¹⁶ to 180*2¹⁶−1, inclusive. The centre_azimuth field 1941 and centre_elevation field 1942 of exemplary 3D orientation metadata data structure 1940 may specify the azimuth and elevation values, respectively, of the centre of the sphere region in units of 2⁻¹⁶ degrees. In some examples, the centre_azimuth 1941 may be in the range of −180*2¹⁶ to 180*2¹⁶−1, inclusive. In some examples, the centre_elevation 1942 may be in the range of −90*2¹⁶ to 90*2¹⁶, inclusive. The centre_tilt field 1943 may specify the tilt angle of the sphere region in units of 2-16 degrees. In some examples, the centre_tilt 1943 may be in the range of −180*2¹⁶ to 180*2¹⁶−1, inclusive.

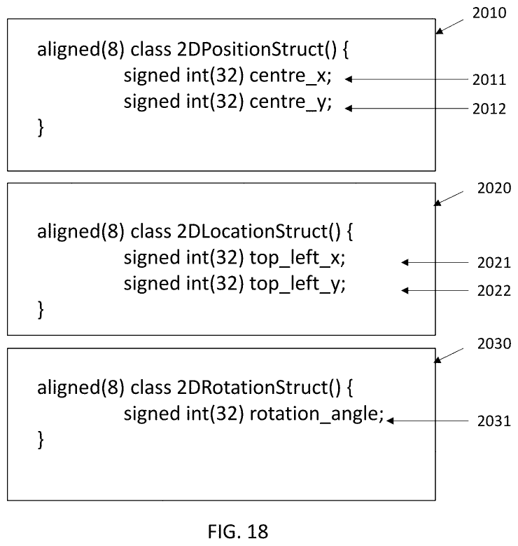

FIG. 18 is an exemplary diagram showing metadata data structures for 2D elements, according to some embodiments. The centre_x field 2011 and centre_y field 2012 of exemplary 2D position metadata data structure 2010 in FIG. 18 may specify the x and y axis values, respectively, of the centre of the 2D region, for example, with respect to the origin of the underlying coordinate system. The top_left_x field 2021, and top_left_y field 2022 of exemplary 2D location metadata data structure 2020 may specify the x, and y axis values, respectively, of the top-left corner of the rectangular region, for example, with respect to the origin of the underlying coordinate system. The rotation_angle field 2031 of exemplary 2D rotation metadata data structure 2030 may specify the angle of the counter-clock rotation that is applied to each of the 2D regions associated in the spatial relationship to convert the local coordinate axes of the 2D region to the global coordinate axes, for example, in units of 2⁻¹⁶ degrees, relative to the global coordinate axes. In some examples, the rotation_angle 2031 may be in the range of −180*2¹⁶ to 180*2¹⁶−1, inclusive.

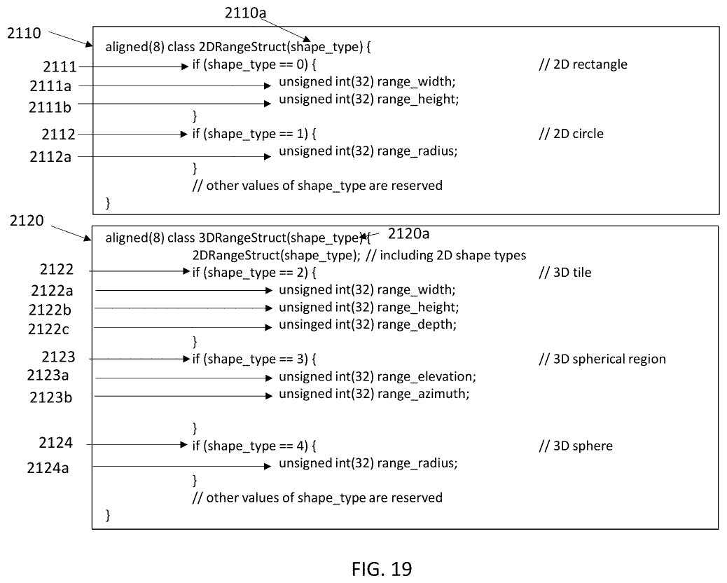

FIG. 19 is an exemplary diagram showing metadata data structures for 2D and 3D range elements 2110 and 2120, according to some embodiments. The range_width fields 2111a and 2122a, and range_height fields 2111b and 2122b may specify the width and height ranges, respectively, of a 2D or 3D rectangular region. They may specify the ranges through a reference point of the rectangular region, which could be either the top left point, centre point, and/or the like inferred as specified in the semantics of the structure containing the instances of these metadata. For example, it may specify the ranges through the centre point of the region. The range_radius fields 2112a and 2124a can specify the radius range of a circular region. The range_azimuth 2123b and range_elevation 2123a may specify the azimuth and elevation ranges, respectively, of the sphere region, for example, in units of 2-16 degrees. The range_azimuth 2123b and range elevation 2123a may also specify the ranges through the centre point of the sphere region. In some examples, the range_azimuth 2123b may be in the range of 0 to 360*2¹⁶, inclusive. In some examples, the range_elevation 2123a may be in the range of 0 to 180*2¹⁶, inclusive.

The shape_type field 2110a and 2120a may specify a shape type of a 2D or 3D region. According to some embodiments, certain values may represent different shape types of a 2D or 3D region. For example, a value 0 may represent a 2D rectangle shape type, a value 1 may represent a shape type of 2D circle, a value 2 may represent a shape type of 3D tile, a value 3 may represent a shape type of 3D sphere region, a value 4 may represent a shape type of 3D sphere, and other values may be reserved for other shape types. According to the value of the shape_type field, the metadata data structures may include different fields, such as can be seen in the conditional statements 2111, 2112, 2122, 2123 and 2124 of exemplary metadata data structures 2110 and 2120.

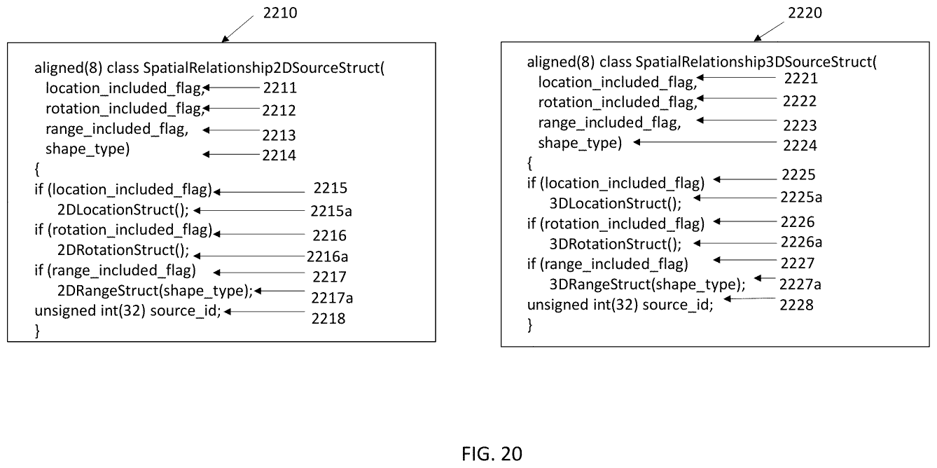

FIG. 20 is an exemplary diagram showing metadata data structures for 2D and 3D sources, according to some embodiments. FIG. 20 includes a spatial relationship 2D source metadata structure 2210 and a spatial relationship 3D source metadata structure 2220. The spatial relationship 2D source metadata structure 2210 includes the location_included_flag 2211, rotation_included_flag 2212, and range_included_flag 2213, which as shown by logic 2215, 2216, and 2217, are used to specify, if applicable, the 2DLocationStruct 2215a, the 2DRotationStruct 2216a, and the 2DRangeStruct 2217a, accordingly. The fields also include the shape_type 2214, and the source_id 2218. The spatial relationship 3D source metadata structure 2220 includes the location_included_flag 2221, rotation_included_flag 2222, and range_included_flag 2223, which as shown by logic 2225, 2226, and 2227, are used to specify, if applicable, the 3DLocationStruct 2225a, the 3DRotationStruct 2226a, and the 3DRangeStruct 2227a, accordingly. The fields also include the shape_type 2224, and the source_id 2228.

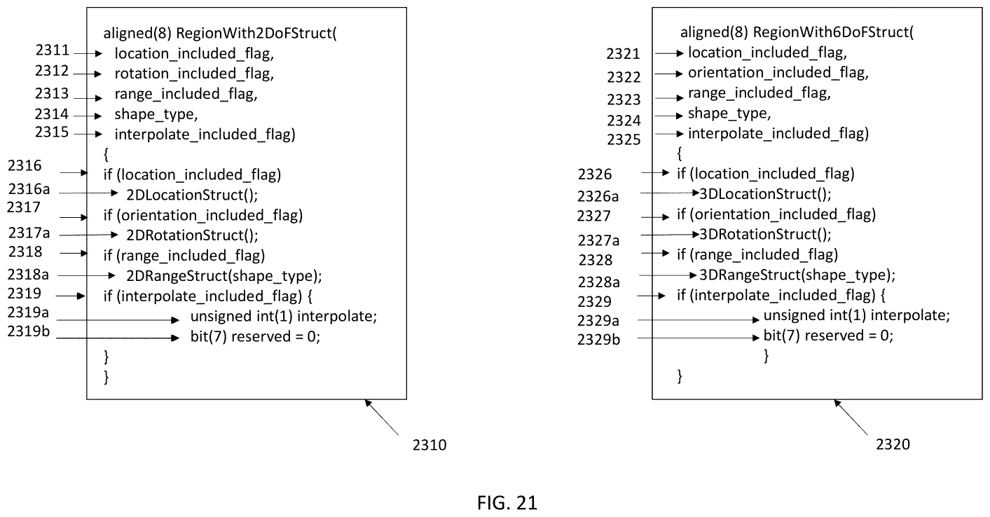

FIG. 21 is an exemplary diagram showing metadata data structures for regions with 2DoF and 6DoFs, according to some embodiments. FIG. 21 includes a region with 2 DoF metadata structure 2310 and region with 6 DoF metadata structure 2320. The region with 2 DoF metadata structure 2310 includes the location_included_flag 2311, rotation_included_flag 2312, range_included_flag 2313, and interpolate_included_flag 2315, which as shown by logic 2316, 2317, 2318, and 2319, are used to specify, if applicable, the 2DLocationStruct 2316a, the 2DRotationStruct 2317, the 2DRangeStruct 2318a, and the interpolate 2319a and reserved field 2319b, accordingly. The fields also include the shape_type 2314. The region with 6 DoF metadata structure 2320 includes the location_included_flag 2321, orientation_included_flag 2322, range_included_flag 2323, and interpolate_included_flag 2325, which as shown by logic 2326, 2327, 2328, and 2329, are used to specify, if applicable, the 3DLocationStruct 2326a, the 3DRotationStruct 2327, the 3DRangeStruct 2328a, and the interpolate 2329a and reserved field 2329b, accordingly. The fields also include the shape_type 2324.

According to some embodiments, interpolate may indicate the continuity in time of the successive samples. According to some embodiments, when interpolate is indicated to be true, the application may linearly interpolate values of the ROI coordinates between the previous sample and the current sample. According to some embodiments, when interpolate is indicated to be false, there may not be any interpolation of values between the previous and the current samples. According to some embodiments, when using interpolation, it may be expected that the interpolated samples match the presentation time of the samples in the referenced track. For example, for each video sample of a video track, one interpolated 2D Cartesian coordinate sample may be calculated. In some embodiments, sync samples for region metadata tracks may be samples for which the interpolate value is 0.

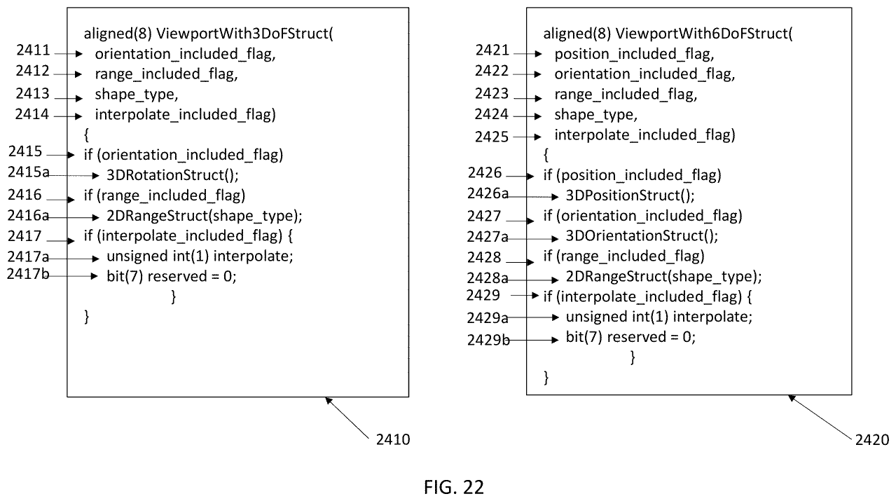

FIG. 22 is an exemplary diagram showing metadata data structures for viewports with 3DoF and 6DoFs 2410 and 2420, according to some embodiments. The viewport with 3DoF 2410 includes the fields orientation_included_flag 2411, range_included_flag 2412, and interpolate_included_flag 2414, which as shown by logic 2415, 2416, and 2417, are used to specify, if applicable, the 3DRotationStruct 2415a, the 3DRangeStruct 2416a, and the interpolate 2417a and reserved field 2417b, accordingly. The fields also include the shape_type 2413. The viewport with 6DoF 2420 includes the fields position_included_flag 2421, orientation_included_flag 2422, range_included_flag 2423, and interpolate_included_flag 2425, which as shown by logic 2426, 2427, 2428, and 2429, are used to specify, if applicable, the 3DPositionStruct 2426a, the 3DOrientationStruct 2427a, the 3DRangeStruct 2428a, and the interpolate 2429a and reserved field 2429b, accordingly. The fields also include the shape_type 2424.

The semantics of interpolate 2319a, 2329a, 2417a, and 2429a may be specified by the semantics of the structure containing this instance of it. According to some embodiments, in the case that any of the location, rotation, orientation, range, shape and interoperate metadata are not present in an instance of 2D and 3D source and region data structures, they may be inferred as specified in the semantics of the structure containing the instance.

In some embodiments, spatial relationships may be signaled within timed metadata tracks. For example, spatial relationships may be signaled using the 2D and 3D spatial source and region metadata data structures as described herein, when individual tracks carry visual content of spatial regions. Spatial relationships within timed metadata tracks to be signaled may include 2D Planar Regions with 2DoF (for Sub-picture tracks), 3D Spherical Regions with 6DoF, 3D Planar Regions with 6DoF, 3D Tile Regions with 6DoF (for PCC 3D Tile Tracks), and/or the like.

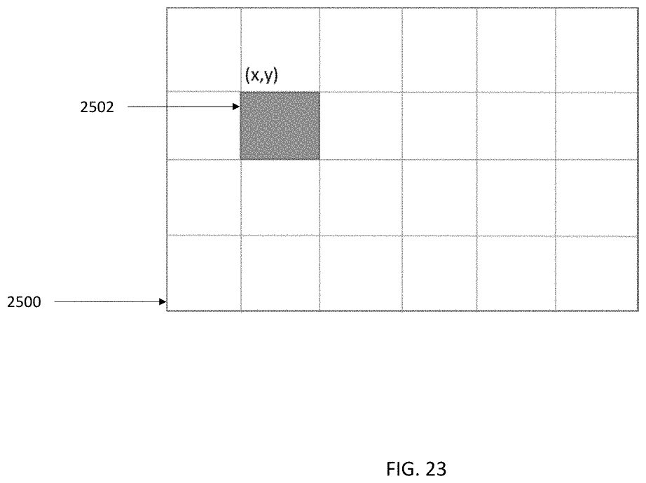

FIG. 23 is an exemplary diagram of 2D planar regions 2500 with 2DoF (e.g., for Sub-pictures in 2D space), according to some embodiments. Element 2502 of FIG. 23 may represent a 2D planar region with 2DoF within a source 2501, according to some embodiments. Each 2D planar region may have a (x, y) position and a width and height, where the width and height may be either explicitly or implicitly signaled. In FIG. 23, 2502 shows the position of the planar region and width and height are not explicitly shown. In some embodiments, the width and height can be inherited from some context or other sources.

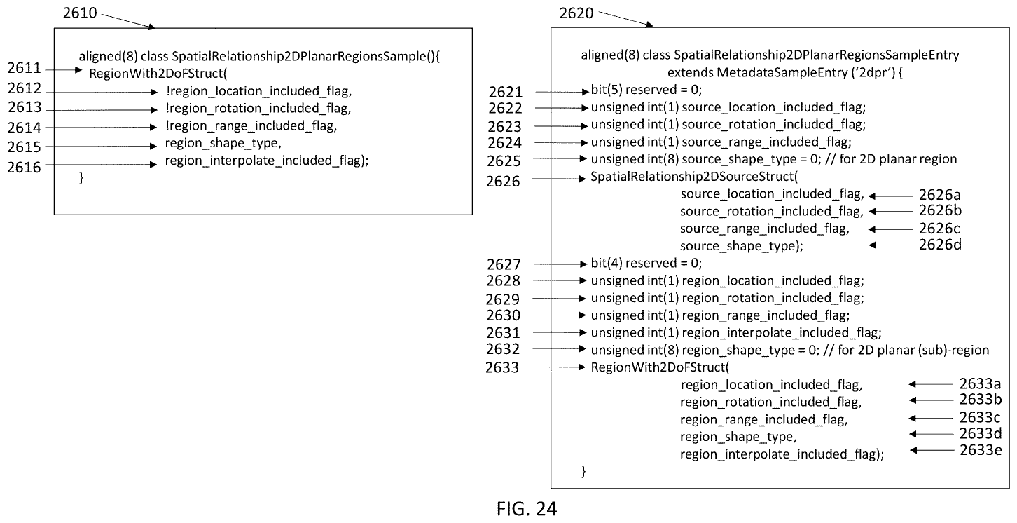

FIG. 24 is an exemplary diagram of a sample entry and sample format for signaling 2D planar regions with 2DoF, according to some embodiments. The SpatialRelationship2DPlanarRegionsS_ample 2610 includes a RegionWith2DoFStruct 2611, which includes a !region_location_included_flag 2612, a !region_rotation_included_flag 2613, a !region_range_included_flag 2614, a region_shape_type 2615, a region_interpolate_included_flag 2616, in this example. The SpatialRelationship2DPlanarRegionsSampleEntry 2620 includes a reserved field 2621, the source_location_included_flag 2622, the source_rotation_included_flag 2623, the source_range_included_flag 2624, and the source_shape_type 2625 (which is equal to 0, and is for a 2D planar region). The SpatialRelationship2DSourceStruct 2626 includes the source_location_included_flag 2626a, source_rotation_included_flag 2626b, source_range_included_flag 2626c, and source_shape_type 2626d. The fields also include a second reserved field 2627, the region_location_included_flag 2628, the region_rotation_included_flag 2629, the region_range_included_flag 2630, the region_interpolate_included_flag 2631, and the region_shape_type 2632 (which is set to 0 and is for a 2D planar (sub)-region). The RegionWith2DoFStruct 2633 includes the region_location_included_flag 2633a, region_rotation_included_flag 2633b, region_range_included_flag 2633c, region shape_type 2633d, and region_interpolate_included_flag 2633e.

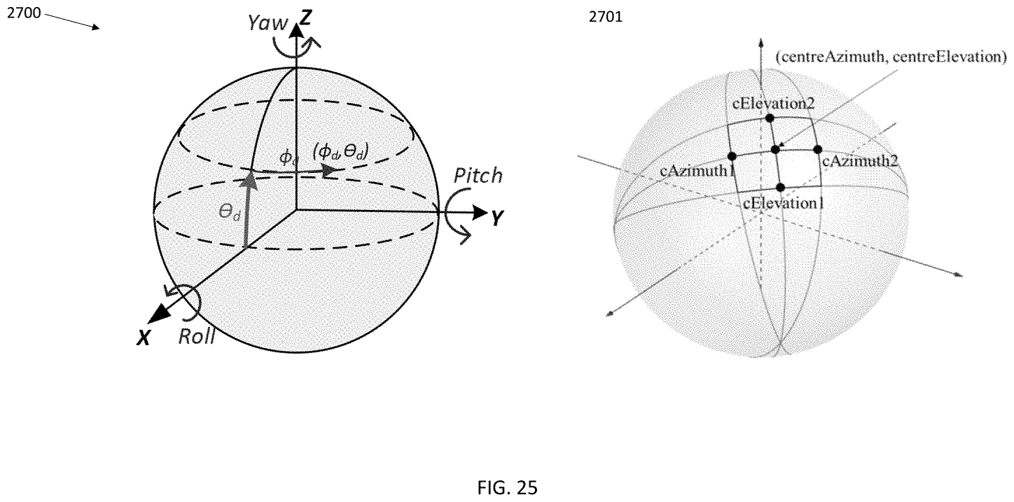

FIG. 25 is an exemplary diagram of 3D spherical regions with 6DoF (e.g. for 3D spherical regions in 3D space and/or the like), according to some embodiments. An exemplary diagram of the directions of the yaw, pitch, and roll rotations can be seen in the spherical illustration 2700. An exemplary diagram of a sphere region specified by four great circles can be seen in 2701. For example, the four great circles may include cAzimuth1, cAzimuth2, cElevation1, and/or cElevation2 as shown in 2701. According to some embodiments, a shape type value equal to 0 as described herein may specify that the sphere region is specified by four great circles as illustrated in FIG. 25.

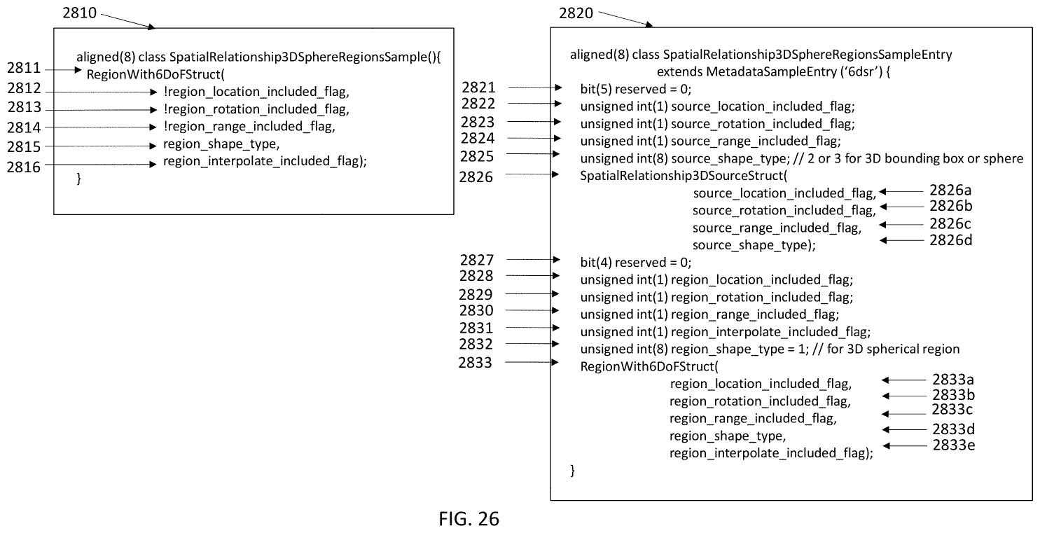

FIG. 26 is an exemplary diagram of a sample entry and sample format for signaling 3D planar regions with 6DoF, according to some embodiments. The SpatialRelationship3DSphereRegionsSample 2810 includes a RegionWith6DoFStruct 2811, which includes a !region_location_included_flag 2812, a !region_rotation_included_flag 2813, a !region_range_included_flag 2814, a region_shape_type 2815, and a region_interpolate_included_flag 2816, in this example. The SpatialRelationship3DSphereRegionsSampleEntry 2820 includes a reserved field 2821, the source_location_included_flag 2822, the source_rotation_included_flag 2823, the source_range_included_flag 2824, and the source_shape_type 2825 (which is equal to 0, and is for a 3D bounding box or region). The SpatialRelationship3DSourceStruct 2826 includes the source_location_included_flag 2826a, source_rotation_included_flag 2826b, source_range_included_flag 2826c, and source_shape_type 2826d. The fields also include a second reserved field 2827, the region_location_included_flag 2828, the region_rotation_included_flag 2829, the region_range_included_flag 2830, the region_interpolate_included_flag 2831, and the region_shape_type 2832 (which is set to 0 and is for a 3D spherical region). The RegionWith6DoFStruct 2833 includes the region_location_included_flag 2833a, region_rotation_included_flag 2833b, region_range_included_flag 2833c, region shape_type 2833d, and region_interpolate_included_flag 2833e.

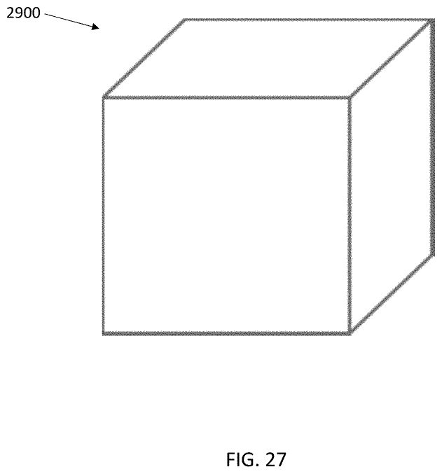

FIG. 27 is an exemplary diagram of 3D planar regions with 6DoF (e.g. for 2D faces/tiles in 3D space and/or the like), according to some embodiments. As described herein, an exemplary diagram of the directions of the yaw, pitch, and roll rotations can be seen in 2700 of FIG. 25. An exemplary 3D planar region 2900 is shown in FIG. 27.

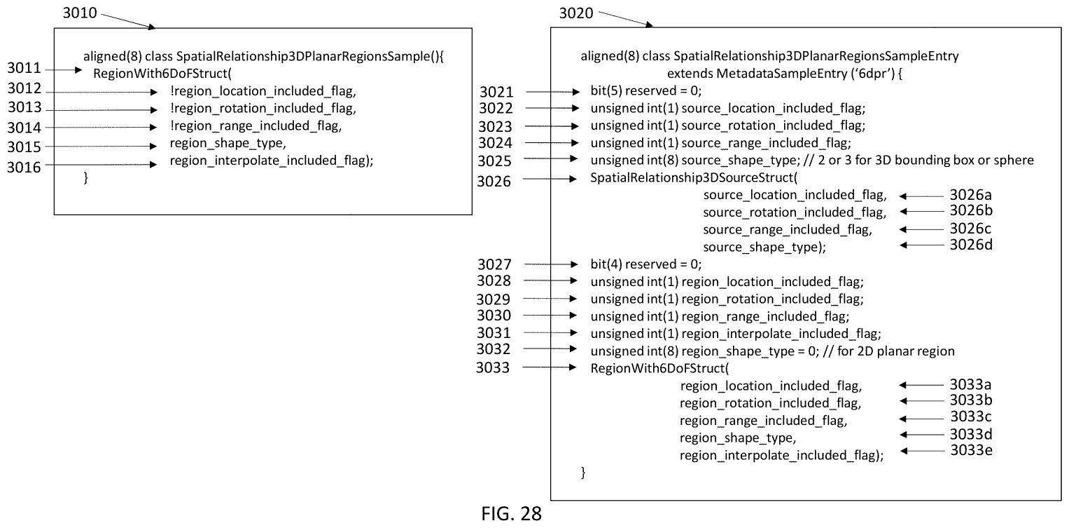

FIG. 28 is an exemplary diagram of a sample entry and sample format for signaling 2D planar regions with 2DoF, according to some embodiments. The SpatialRelationship3DPlanarRegionsSample 3010 includes a RegionWith6DoFStruct 3011, which includes a !region_location_included_flag 3012, a !region_rotation_included_flag 3013, a !region_range_included_flag 3014, a region_shape_type 3015, and a region_interpolate_included_flag 3016, in this example. The SpatialRelationship3DPlanarRegionsSampleEntry 3020 includes a reserved field 3021, the source_location_included_flag 3022, the source_rotation_included_flag 3023, the source_range_included_flag 3024, and the source_shape_type 3025 (which is equal to 2 or 3 for a 3D bounding box or sphere). The SpatialRelationship3DSourceStruct 3026 includes the source_location_included_flag 3026a, source_rotation_included_flag 3026b, source_range_included_flag 3026c, and source_shape_type 3026d. The fields also include a second reserved field 3027, the region_location_included_flag 3028, the region_rotation_included_flag 3029, the region_range_included_flag 3030, the region_interpolate_included_flag 3031, and the region shape_type 3032 (which is set to 0 and is for a 2D planar region). The RegionWith6DoFStruct 3033 includes the region_location_included_flag 3033a, region_rotation_included_flag 3033b, region_range_included_flag 3033c, region_shape_type 3033d, and region_interpolate_included_flag 3033e.

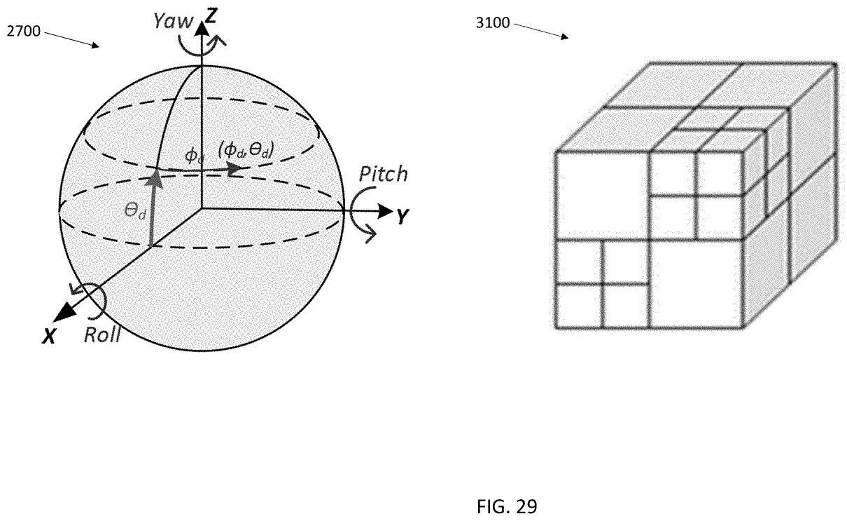

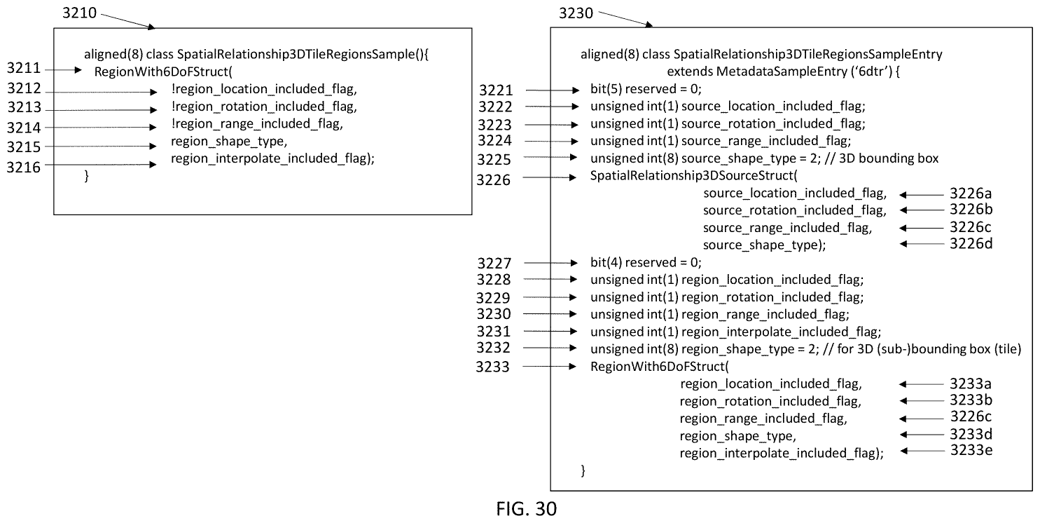

FIG. 29 is an exemplary diagram of 3D tile regions with 6DoF (for PCC 3D Tiles), according to some embodiments. As described herein, an exemplary diagram of the directions of the yaw, pitch, and roll rotations can be seen in 2700. An exemplary 3D tile region can be seen in 3100. FIG. 30 is an exemplary diagram of a sample entry and sample format for signaling 3D tile regions with 6DoF, according to some embodiments. The SpatialRelationship3DTileRegionsSample 3210 includes a RegionWith6DoFStruct 3211, which includes a !region_location_included_flag 3212, a !region_rotation_included_flag 3213, a !region_range_included_flag 3214, a region shape_type 3215, and a region_interpolate_included_flag 3216, in this example. The SpatialRelationship3DTileRegionsSampleEntry 3220 includes a reserved field 3221, the source_location_included_flag 3222, the source_rotation_included_flag 3223, the source_range_included_flag 3224, and the source_shape_type 3225 (which is equal to 2 for a 3D bounding box). The SpatialRelationship3DSourceStruct 3226 includes the source_location_included_flag 3226a, source_rotation_included_flag 3226b, source_range_included_flag 3226c, and source_shape_type 3226d. The fields also include a second reserved field 3227, the region_location_included_flag 3228, the region_rotation_included_flag 3229, the region_range_included_flag 3230, the region_interpolate_included_flag 3231, and the region_shape_type 3232 (which is set to 20 and is for a 3D (sub-)bounding box (tile)). The

RegionWith6DoFStruct 3233 includes the region_location_included_flag 3233a, region_rotation_included_flag 3233b, region_range_included_flag 3233c, region_shape_type 3233d, and region_interpolate_included_flag 3233e.

In some embodiments, as described herein individual tracks carry visual content of spatial regions. In such embodiments, spatial relationships may be signaled within track group boxes using the 2D and 3D spatial source and region metadata data structures described herein. Spatial relationships that may be signaled within track group boxes may include, for example, 2D Planar Regions with 2DoF (for Sub-picture tracks), 3D Spherical Regions with 6DoF, 3D Planar Regions with 6DoF, 3D Tile Regions with 6DoF (for PCC 3D Tile Tracks), and/or the like.

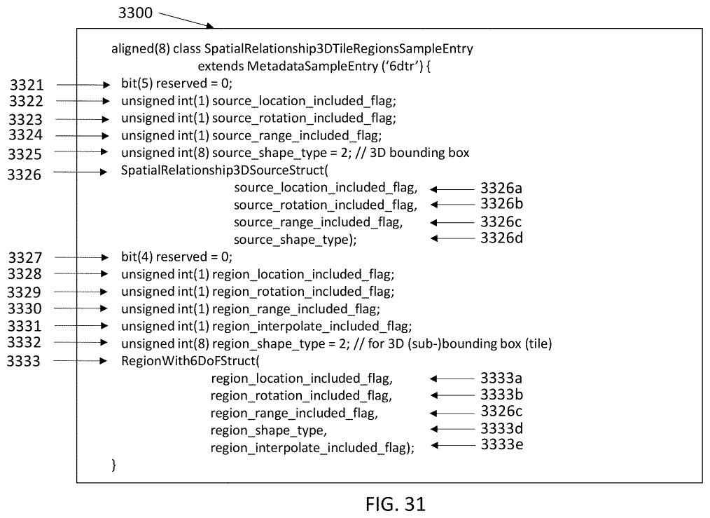

FIG. 31 is an exemplary diagram showing signaling of 2D planar regions with 2DoF spatial relationship of spatial regions in track groups, according to some embodiments. The SpatialRelationship3DTileRegionsSampleEntry 3300 includes a reserved field 3321, the source_location_included_flag 32322, the source_rotation_included_flag 3323, the source_range_included_flag 3324, and the source_shape_type 3325 (which is equal to 2 for a 3D bounding box). The SpatialRelationship3DSourceStruct 3326 includes the source_location_included_flag 3326a, source_rotation_included_flag 3326b, source_range_included_flag 3326c, and source_shape_type 3326d. The fields also include a second reserved field 3327, the region_location_included_flag 3328, the region_rotation_included_flag 3329, the region_range_included_flag 3330, the region_interpolate_included_flag 3331, and the region shape_type 3332 (which is set to 2 and is for a 3D (sub-)bounding box (tile)). The RegionWith6DoFStruct 3333 includes the region_location_included_flag 3333a, region_rotation_included_flag 3333b, region_range_included_flag 3333c, region shape_type 3333d, and region_interpolate_included_flag 3333e.

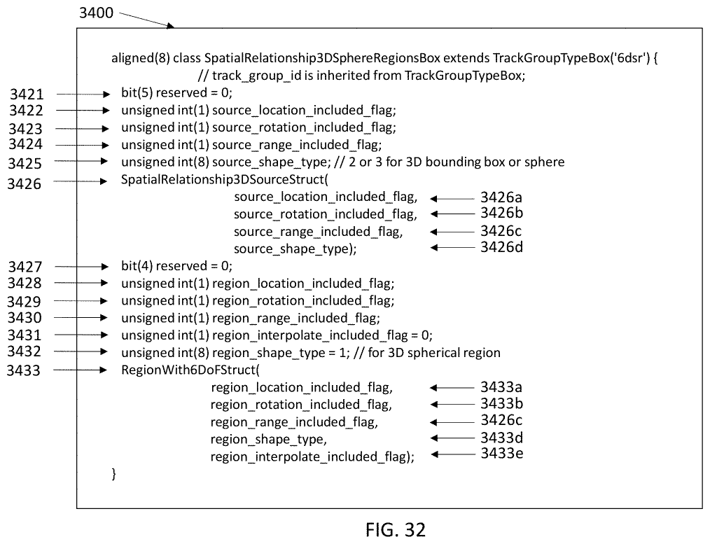

FIG. 32 is an exemplary diagram showing signaling of 3D spherical regions with 6DoF spatial relationship of spatial regions in track groups, according to some embodiments. The SpatialRelationship3DSphereRegionsSampleEntry 3400 includes a reserved field 3421, the source_location_included_flag 3422, the source_rotation_included_flag 3423, the source_range_included_flag 3424, and the source_shape_type 3425 (which is equal to 2 or 3 for a 3D bounding box or sphere). The SpatialRelationship3DSourceStruct 3426 includes the source_location_included_flag 3426a, source_rotation_included_flag 3426b, source_range_included_flag 3426c, and source_shape_type 3426d. The fields also include a second reserved field 3427, the region_location_included_flag 3428, the region_rotation_included_flag 3429, the region_range_included_flag 3430, the region_interpolate_included_flag 3431, and the region shape_type 3432 (which is set to 1 and is for a 3D spherical region). The RegionWith6DoFStruct 3433 includes the region_location_included_flag 3433a, region_rotation_included_flag 3433b, region_range_included_flag 3433c, region shape_type 3433d, and region_interpolate_included_flag 3433e.

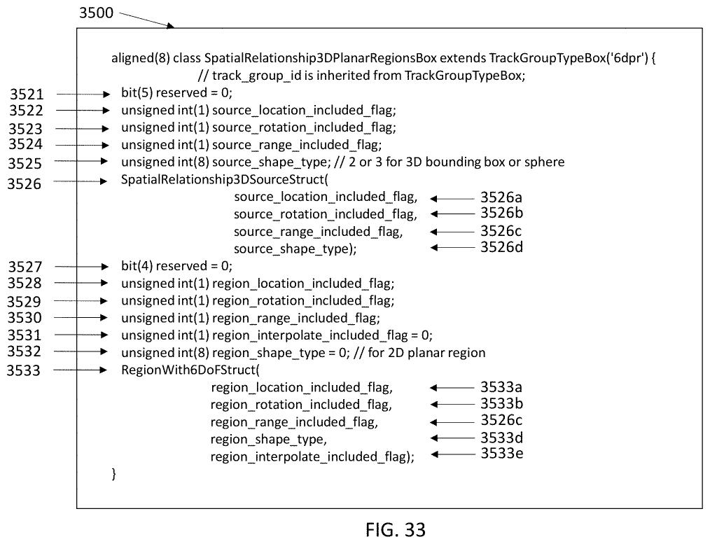

FIG. 33 is an exemplary diagram showing signaling of 3D planar regions with 6DoF spatial relationship of spatial regions in track groups, according to some embodiments. The SpatialRelationship3DTileRegionsSampleEntry 3520 includes a reserved field 3521, the source_location_included_flag 3522, the source_rotation_included_flag 3523, the source_range_included_flag 3524, and the source_shape_type 3525 (which is equal to 2 or 3 for a 3D bounding box or sphere). The SpatialRelationship3DSourceStruct 3526 includes the source_location_included_flag 3526a, source_rotation_included_flag 3526b, source_range_included_flag 3526c, and source_shape_type 3526d. The fields also include a second reserved field 3527, the region_location_included_flag 3528, the region_rotation_included_flag 3529, the region_range_included_flag 3530, the region_interpolate_included_flag 3531, and the region_shape_type 3532 (which is set to 0 and is for a 2D planar region). The RegionWith6DoFStruct 3533 includes the region_location_included_flag 3533a, region_rotation_included_flag 3533b, region_range_included_flag 3533c, region_shape_type 3533d, and region_interpolate_included_flag 3533e.

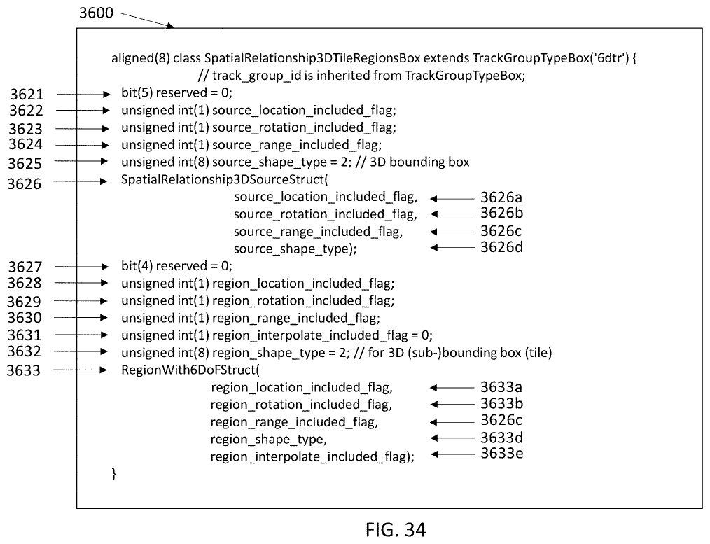

FIG. 34 is an exemplary diagram showing signaling of 3D tile regions with 6DoF spatial relationship of spatial regions in track groups, according to some embodiments. The SpatialRelationship3DTileRegionsBox 3600 includes a reserved field 3621, the source_location_included_flag 3622, the source_rotation_included_flag 3623, the source_range_included_flag 3624, and the source_shape_type 3625 (which is equal to 2 for a 3D bounding box). The SpatialRelationship3DSourceStruct 3626 includes the source_location_included_flag 3626a, source_rotation_included_flag 3626b, source_range_included_flag 3626c, and source_shape_type 3626d. The fields also include a second reserved field 3627, the region_location_included_flag 3628, the region_rotation_included_flag 3629, the region_range_included_flag 3630, the region_interpolate_included_flag 3631, and the region_shape_type 3632 (which is set to 2 and is for a 3D (sub-)bounding box (tile)). The RegionWith6DoFStruct 3633 includes the region_location_included_flag 3633a, region_rotation_included_flag 3633b, region_range_included_flag 3633c, region_shape_type 3633d, and region_interpolate_included_flag 3633e.

According to some embodiments, a viewport with 3DoF,6DoF, and/or the like can be signaled using a timed metadata track. In some embodiments, when the viewport is only signaled at the sample entry, it is static for all samples within; otherwise, it is dynamic, with some attributes of it varying from sample to sample. According to some embodiments, a sample entry may signal information common to all samples. In some examples, the static/dynamic viewport variation can be controlled by a number of flags specified at the sample entry.

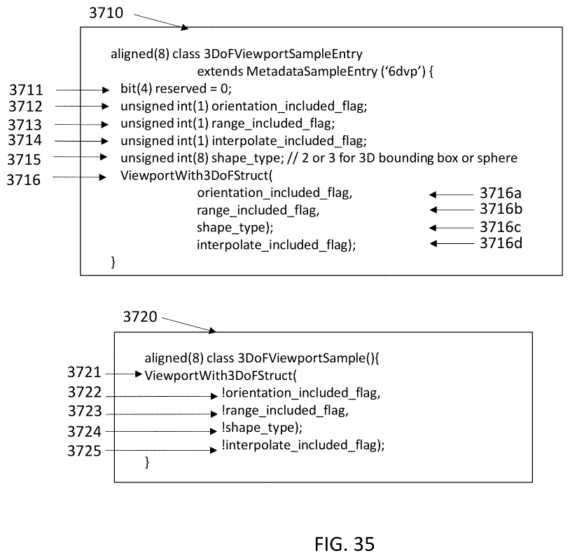

FIG. 35 is a diagram of exemplary sample entry and sample format for signaling a viewport with 3DoF (e.g. for 2D faces/tiles in 3D space and/or the like) in timed metadata tracks. The 3DoFViewportSampleEntry 3710 includes a reserved field 3711, orientation_included_flag 3712, range_included_flag 3713, interpolate_included_flag 3714, and shape_type 3715 (which is 2 or 3 for a 3D bounding box or sphere). The fields also include a ViewportWith3DoFStruct 3716, which includes the orientation_included_flag 3716a, range_included_flag 3716b, and shape_type 3716c. The fields also include the interpolate_included_flag 3716d. The 3DoFViewportSample 3720 includes a ViewportWith3DoFStruct 3721, which includes the fields !orientation_included_flag 3722, !range_included_flag 3723, !shape_type 3724, and !interpolate_included_flag 3725.

As described herein, interpolate may indicate the continuity in time of the successive samples. According to some embodiments, when interpolate is indicated to be true, the application may linearly interpolate values of the ROI coordinates between the previous sample and the current sample. According to some embodiments, when interpolate is indicated to be false, there may not be any interpolation of values between the previous and the current samples. According to some embodiments, when using interpolation, it may be expected that the interpolated samples match the presentation time of the samples in the referenced track. For example, for each video sample of a video track, one interpolated 2D Cartesian coordinate sample may be calculated. In some embodiments, sync samples for region metadata tracks may be samples for which the interpolate value is 0.

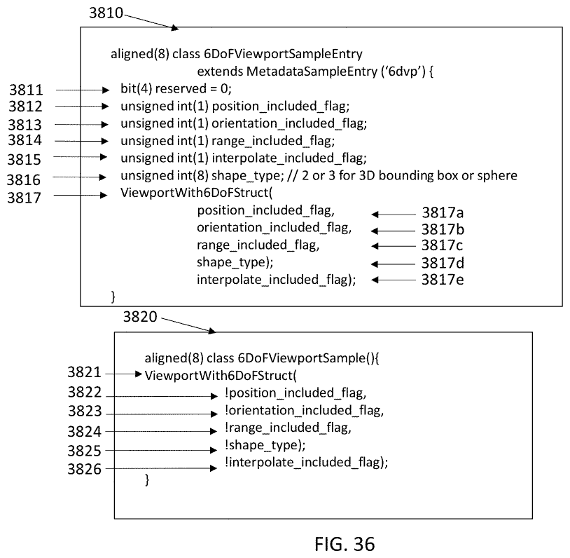

FIG. 36 is a diagram of exemplary sample entry and sample format for signaling a viewport with 6DoF e.g. for 2D faces/tiles in 3D space and/or the like) in timed metadata tracks, according to some embodiments. The 6DoFViewportSampleEntry 3810 includes a reserved field 3811, position_included_flag 3812, orientation_included_flag 3813, range_included_flag 3814, interpolate_included_flag 3815, and shape_type 3816 (which is 2 or 3 for a 3D bounding box or sphere). The fields also include a ViewportWith6DoFStruct 3817, which includes the position_included_flag 3817a, orientation_included_flag 3817b, range_included_flag 3817c, and shape_type 3817d. The fields also include the interpolate_included_flag 3817e. The 6DoFViewportSample 3820 includes a ViewportWith6DoFStruct 3821, which includes the fields !posiiton_included_flag 3822, !orientation_included_flag 3823, !range_included_flag 3824, !shape_type 3825, and !interpolate_included_flag 3826.

As described in conjunction with FIGS. 3-4, point cloud content can provide immersive media with 6DoF in the 3D space (e.g., where in 3DoF, the user can only turn their head around, whereas with 6DoF, the user can walk around the scene). According to some embodiments, a viewport can be a projection of texture onto a planar surface of a field of view of an omnidirectional or 3D image or video. Such a viewport can be suitable for display and viewing by the user with a particular viewing orientation and viewing position.

As described herein, the immersive media content can be broken into small portions (e.g., tiles) in order to provide for only delivering tiles that include content that the user will see. According to some embodiments, a user's viewport and/or a region in the immersive media (where a region is more general than viewports, in the sense that regions can have less constraints than regions) can therefore be made up of a set of tiles. Thus, the techniques can provide for breaking immersive media content into tiles, and only delivering those tiles that apply to a particular region. Referring to FIG. 2, for example, the bounding box 502 can represent the source immersive media content, which is the original content that will be divided into tiles. The 3D bounding boxes 506, 508 and 510 can represent the tiles. As described further herein, regions can be encoded into the tiled content, and the techniques can provide for only delivering the tiles that cover a particular region over to the client playback device side. As shown in FIG. 5, the viewport 518 has an (x,y,z) location and is a view of the surface of the content 502. What is displayed on that surface is the viewport. Since the user's viewport can change, the techniques are adaptive for the user's viewport as it changes over time. The techniques can further support other viewport scenarios, such as editor cuts for preferred viewports.

Referring to FIG. 9, the V-PCC container 900 shows a technique for encapsulating the immersive media content into multiple tracks. Each V-PCC bit stream has component tracks, including the occupancy track 912, the geometry track 908, and the component track 910. The container 900 further includes the volumetric track 906, which includes metadata used in conjunction with the component tracks to construct the data.

When a 3D source, such as a point-cloud, is sub-divided into multiple regions, like sub-point-clouds (or V-PCC tiles), for the purposes of partial delivery and access (e.g. such as is described in N18663, “Description of Core Experiment on partial access of PC data,” July 2019, Gothenburg, SE, which is hereby incorporated by reference herein in its entirety), the regions can be encapsulated at either the V-PCC bit-stream level or the patch data group level (e.g. such as is described in N18606, “Text of ISO/IEC CD 23090-10 Carriage of PC Data”, July 2019, Gothenburg, SE, which is hereby incorporated by reference herein in its entirety). Thus, as described further herein, the inventors have discovered and appreciated that if the immersive media content is divided into different tiles, it can be desirable to signal regions in the tiled content.

For example, each tile can be encoded (a) as a separate bit stream (with separate component tracks) and/or (b) as part of the same bitstream with the same component tracks, such that the tiles are encoded using different V-PCC tracks at the patch level. Therefore, in some embodiments, each tile can be encoded as its own bitstream, and the component tracks for each tile can be different. In some embodiments, alternatively or additionally, the same component tracks can be used and different V-PCC tracks (e.g., tracks 906) can be used for each tile to encapsulate the tiles at the patch level. A patch can be a 2D view of a 3D object. For example, referring to FIG. 5, the bounding box 510 can be encoded as a patch group track, where each patch is one view of the 3D bounding box 510 such that the six faces of the bounding box 510 can correspond to six patches.

Those six patches can be encoded into a patch group track, which essentially specifies the metadata of the bounding box 510. Therefore, according to some embodiments, one bitstream can specify one set of component tracks and the V-PCC track can specify the six patches for a bounding box (and another track can specify the next patch group for the middle region 508, and so on). Various patches can be used, including some patches that view a bounding box from a 45 degree angle (e.g., which would add four more patches to the six for the faces for embodiments that have six patches), and/or the like.

Some embodiments of the techniques described herein relate to signaling regions (e.g., smaller portions within tiled content that can include content from a set of one or more tiles). According to some embodiments, V-PCC regions (as an example of regions) can be signaled at the V-PCC bit-stream and patch data group levels, in order to encapsulate V-PCC content of regions, respectively, (a) in multiple groups of ISOBMFF volumetric and component tracks (e.g. as described in N18606), in that each group of the tracks represents a region, and corresponds to a V-PCC bit-stream, and/or (b) in multiple ISOBMFF volumetric tracks coupled with common component tracks (e.g. as described in N18606), in that each volumetric track represents a region and corresponds to a patch data group, when it is coupled with the common component tracks within a same V-PCC bit-stream.

According to some embodiments, the spatial relationship of regions (e.g. V-PCC regions and/or the like) and their source can be signed using the track grouping box mechanism and the timed metadata track mechanism described herein.

According to some embodiments, the track grouping box mechanism may be used to signal the spatial relationship of regions and their source. In some embodiments of the track grouping box mechanism, each volumetric track may carry a TrackGroupTypeBox of type ‘6dtr’, SpatialRelationship3DTileRegionsBox. In some embodiments, volumetric tracks with track grouping boxes can contain a same source_id may represent regions of a same source, when coupled with their corresponding component tracks. According to some embodiments, this mechanism may cover both cases of encapsulating V-PCC regions, as described above (i.e., the track grouping box mechanism may be used (a) for regions encoded at the bitstream level and/or (b) for regions encoded at the patch level). In some embodiments, the V-PCC track can carry the grouping box. For example, when encoding regions at the bitstream level, then the V-PCC track can carry the grouping box to indicate the position of the region. Each track can have its own track grouping box to indicate the position of the region (e.g., if the position of the region is the top 510, middle 508, or bottom 506, based on the (x,y,z) position of the region). As another example, when tiles are carried at the patch level, the grouping box can be carried in the V-PCC tracks (e.g., rather than in the component tracks). Using the track group box can include various benefits, such as signaling static regions, since the track grouping box only needs to be specified once. However, in some situations, it may not always be efficient and even feasible to use the track group box for signaling regions, such as for dynamically changing ones.

According to some embodiments, the timed metadata track mechanism may be used to signal the spatial relationship of regions and their source. In some embodiments of the timed metadata track mechanism, each volumetric track may be referenced by a timed metadata track of sample entry type ‘6dtr’. According to some embodiments, this mechanism may cover both cases of encapsulating V-PCC regions, as described above. In some embodiments, volumetric tracks referenced by timed metadata tracks with a same source_id may represent regions of a same source, when coupled with their corresponding component tracks. According to some embodiments, the spatial relationship of the regions can be carried in the sample entry of the timed metadata track and make reference to the volumetric track of that region. Using timed metadata tracks can provide for various benefits. For example, timed metadata tracks can be used to specify regions for their referenced media tracks. For example, one metadata track can specify a region for the set of tracks (e.g., region 510 in FIG. 5), and another timed metadata track can specify a different region for the tracks (e.g., the middle region 508). Thus, if there are multiple regions in tiled content, multiple timed metadata tracks can be used to reference a single set of tracks, one for each region. As another example, timed metadata tracks can be used to specify dynamically changing/moving regions. For example, the position and/or size of a region can change over time. A timed metadata track can describe how a region changes in terms of position, size, location, and/or the like. Thus, the immersive media content can be encoded once, and regions can be specified in the source using different timed metadata tracks. Timed metadata tracks can also be useful in signaling static regions, especially for those static ones identified after media tracks have been created and not being able to signaled without changing the media tracks themselves, e.g., by introducing new track group boxes into the media tracks.

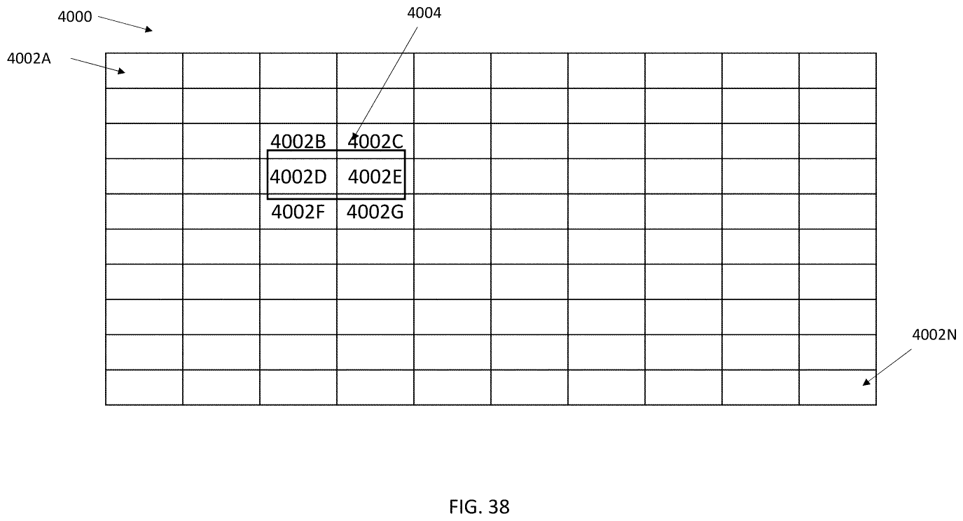

FIG. 38 shows an example of a region in a partitioned immersive media stream, according to some embodiments. In this illustrative example, assume a V-PCC stream 4000 is partitioned into 10×10 tiles, such that there are 100 (leading) volumetric tracks 4002A-4002N, collectively referred to as volumetric tracks 4002 (e.g., using an approach as discussed herein in conjunction with FIGS. 11-12). According to some embodiments, each tile may be encoded as a set of immersive tracks where each set of tracks may be encoded as separate bitstreams or as different patch tracks. According to some embodiments, the V-PCC stream may be representative of the entire immersive media content, wherein the immersive media content is broken into tiles, and each tile is encoded using one bitstream or separate bitstreams. According to some embodiments, each tile may correspond to a single volumetric track. In some embodiments, all of the tiles and/or volumetric tracks may be encoded using a single bitstream and/or separate bitstreams.

According to some embodiments, a tile may be encoded with at least one volumetric track. For example, with at least one leading volumetric track. In some embodiments, component information can be encoded within the volumetric track, as a separate set of component tracks of its own, and/or as a separate set of component tracks shared with other tiles.

Referring further to FIG. 38, as described herein, if using a track grouping box, those volumetric tracks 4000 can each have a track grouping box to indicate that they belong to the same V-PCC stream. The techniques described herein can be used to indicate that this V-PCC stream contains the small region 4004. According to some embodiments, a track grouping box approach can be used to group tracks 4002B-4002G together using a box additional to the box that groups all of the 100 tiles. According to some embodiments, a timed metadata track can be used to group tracks 4002B-4002G together, referencing to either tracks 4002B-4002G or the track group of all the 100 tile tracks, to say that those tracks 4002B-4002G or the track group have a region.

The MPEG Dynamic Adaptive Streaming over HTTP (DASH) protocol is an adaptive bitrate streaming technique that leverages conventional HTTP web servers to deliver adaptive content over the Internet. MPEG DASH breaks the content into a sequence of small file segments, each of which includes a short period of multimedia content that is made available at a variety of different bit rates. When using MPEG DASH, a client can select which of the various bit rates to download based on the current network conditions, often being configured to select the highest bit rate that can be downloaded without affecting playback. Thus, the MPEG DASH protocol allows a client to adapt to changing network conditions.

For DASH applications, the content usually has a corresponding Media Presentation Description (MPD) file. The MPD provides sufficient information for the DASH client to facilitate adaptive streaming of the content by downloading the media segments from an HTTP DASH server. The MPD is an Extensible Markup Language (XML) document that contains information about the media segments, their relationships and information necessary for the HTTP DASH client to choose among the segments, and other metadata that may be needed by the HTTP DASH client.

The MPD can have a hierarchical structure, with the “MPD” element being the root element, which can include various parts such as basic MPD settings, Period, Adaptation Set, Representation, Segment, and/or the like. The Period can describe a part of the content with a start time and a duration. Periods can be used, for example, to represent scenes or chapters, to separate ads from program content, and/or the like. The Adaptation Set can contain a media stream or a set of media streams. In a basic example, a Period could have one Adaptation Set containing all audio and video for the content. But, more typically (e.g., to reduce bandwidth), each stream can be split into a different Adaptation Set. For example, multiple Adaptation Sets can be used to have one video Adaptation Set, and multiple audio Adaptation Sets (e.g., one for each supported language). Representations allow an Adaptation Set to contain the same content encoded in different ways. For example, it is common to provide Representations in multiple screen sizes, bandwidths, coding schemes, and/or the like. Segments are the actual media files that the DASH client plays, generally by playing them back-to-back as if they were the same file. Media Segment locations can be described using a BaseURL for a single-segment Representation, a list of segments (SegmentList), a template (SegmentTemplate) with SegmentBase, or xlink (e.g., the xlink in the top level-element, Period). Segment start times and durations can be described with a SegmentTimeline (especially important for live streaming, so a client can quickly determine the latest segment). The BaseURL, SegmentList, and SegmentTemplate are specified in the Period. Segments can be in separate files (e.g., for live streaming), or they can be byte ranges within a single file (e.g., for static or on-demand content).

In some embodiments, the techniques described herein can be used for streaming applications, such as for DASH applications. For example, with the storage and signaling mechanisms of using overlay timed metadata tracks and overlay derived tracks, a track to be constructed from other N visual tracks and items (N>1) can be streamed using DASH (e.g., as described in N17233, “Text of ISO/IEC 23009-1 3rd edition,” April 2018, San Diego, Calif. USA, which is hereby incorporated by reference herein in its entirety) and ISOBMFF (e.g., as described in N16169).

The inventors have developed improvements to existing streaming techniques to support region representations in tiled immersive media content. According to some embodiments, a streaming manifest file (e.g., a DASH manifest file) can include a representation corresponding to each track (e.g., each volumetric track and each component track in a V-PCC container). According to some embodiments, a volumetric representation in DASH for a volumetric track can be a dependent representation that lists the ids of all of the complementary component representations for its component tracks (e.g., using @dependencyId, as described herein). According to some embodiments, regions can be signaled using track grouping boxes of volumetric tracks. For example, as described herein, for each region, depending on how it is encapsulated, a 3D extension of the 2D Spatial Relationship Description (SRD) scheme can be used, which is a descriptor in the DASH manifest that specifies how 2D subpicture regions are related (described further herein in conjunction with the 3D SRD scheme. In some embodiments, if regions are singled in timed metadata tracks, a representation can be used for the timed metadata tracks (e.g., which can be associated with their volumetric representations, such as by using @associationID to list the IDs of the volumetric representations, as described herein). In some embodiments, if viewports are signaled using timed metadata tracks (e.g., the viewport 518 discussed in FIG. 5), a timed metadata representation can be used to signal the viewport. For example, conceptually a viewport can be treated similarly to a region, but can include additional metadata (e.g., about the position, orientation, and size of the field of view). That additional information can be carried in the timed metadata track, and DASH can specify a representation for that viewport (e.g., and use @associationID to list the IDs, as discussed herein).

When 3D video content, such as V-PCC content, is encapsulated in ISOBMFF (e.g. in the manner described in N18606), its regions can be signaled in timed metadata tracks, track groups, and/or the like.

In some embodiments, where regions of 3D video content are signaled in timed metadata tracks and/or track groups, volumetric tracks and component tracks may each have their own corresponding DASH representations. According to some embodiments, a volumetric representation in DASH for a volumetric track may be a dependent representation, with attribute @dependencyId to list the Id's of all the complementary component representations for its component tracks. According to some embodiments, when a volumetric track represents a region, when together with its component tracks, its corresponding volumetric representation represents a region for streaming, together with the complimentary representations.

In some embodiments, if the region metadata of the regions is carried in timed metadata tracks, then the timed metadata representations for the timed metadata tracks may be associated with their volumetric representations, via attribute @associationId to list the id's of all the volumetric representations of the tracks that the timed metadata track references to.

In some embodiments, if the viewport metadata of a viewport are carried in a timed metadata track, then the timed metadata representation for the timed viewport metadata track may be associated with its volumetric representations, via attribute @associationId to list the id's of all the volumetric representations of the tracks that the timed metadata track references to.

In some embodiments, if the region metadata of the regions are carried in track grouping boxes of volumetric tracks, then it may be proposed to use the 3D extension of the (2D) SRD scheme to specify spatial relationships among the 3D regions (objects) as described herein.

The 3D Spatial Relationship Description (SRD) scheme can allow Media Presentation Description authors to express spatial relationships between 3D Spatial Objects. According to some embodiments, a Spatial Object may be represented by either an Adaptation Set or a Sub-Representation. As an example, a spatial relationship may express that a 3D video represents a 3D spatial part of another full-size 3D video (e.g. a 3D region of interest, or a 3D tile).

According to some embodiments, the SupplementalProperty and/or EssentialProperty descriptors with @schemeIdUri equal to “urn:mpeg:dash:3dsrd:20xx” and “urn:mpeg:dash:3dsrd:dynamic:20xx” may be used to provide spatial relationship information associated to the containing Spatial Object. In some embodiments, SRD information may be contained exclusively in these two MPD elements (AdaptationSet and SubRepresentation). According to some embodiments, to preserve the compatibility with legacy clients, MPD may use SupplementalProperty and EssentialProperty in such a way that at least one Representation can be interpreted by legacy clients after discarding the element containing EssentialProperty. According to some embodiments, Sub-Representation level SRDs can be used to represent Spatial Objects in one Representation, such as HEVC tiling streams. In some examples, when the Sub-Representation level SRDs are used to represent Spatial Objects in one Representation, SRD descriptors can be present at Adaptation Set as well as Sub-Representation levels.

According to some embodiments, the @value of the SupplementalProperty or EssentialProperty elements using the 3D SRD scheme may be a comma-separated list of values for 3D SRD parameters. According to some embodiments, when the @value is not present, the 3D SRD may not express any spatial relationship information at all and can be ignored.

According to some embodiments, the source_id parameter may provide a unique identifier, within the Period, for the source of the content. In some embodiments, the source_id parameter may implicitly specify a coordinate system associated to this source. In some examples, the coordinate system may an arbitrary origin (0; 0; 0), the x-axis may be oriented from left to right, the y-axis may be oriented from top to bottom and the z-axis may be oriented from near to far. According to some embodiment, all SRD sharing the same source_id value may have the same origin and axes orientations. Spatial relationships for Spatial Objects using SRD with different source_id values are unspecified.

In some embodiments, for a given source_id value, a reference space may be specified, corresponding to the rectangular region encompassing the entire source content, whose near-top-left corner is at the origin of the coordinate system. In some embodiments, the total_width, total_height and total_depth values in a SRD provide the size of the reference space expressed in arbitrary units.

In some embodiments, there may be no Spatial Object in the MPD that covers the entire source of the content, e.g. when the entire source content is represented by two separate videos.

According to some embodiments, MPD authors can express, using the spatial_set_id parameter, that some Spatial Objects, within a given source_id, have a particular spatial relationship. For example, an MPD author may group all Adaptation Sets corresponding to tiles at a same resolution level. This way, the spatial_set_id parameter may be used by the DASH client to quickly select spatially related Spatial Objects. When two or more groups of full-frame video which consists of one or more Spatial Objects with the same total_width, total_height and total_depth value, different values of spatial_set_id can be used to distinguish the groups of full-frame video. For example, N17233 describes examples that show usage of spatial_set_id.

In some embodiments, certain parameters may be used for static spatial description. According to some embodiments, for example, a Scheme Identifier may be used, for example “urn:mpeg:dash:3dsrd:20xx”, to express static description within the scope of the Period.

According to some embodiments, the centre_x 1911, centre_y 1921 and centre_z 1922 parameters described herein may express 3D positions, rotation_yaw 131, rotation_pitch 132 and rotation_roll 133, may express3D rotations and range_width, range_height and range_depth may express sizes of the associated Spatial Object in the 3D coordinate system associated to the source. According to some embodiments, the values of the object_x, object_y, object_z, object_width, total_height, and total_depth parameters are relative to the values of the total_width, total_height, and total_depth parameters, as specified above. Positions (e.g. (object_x, object_y, object_z), and/or the like) and sizes (e.g. (object_width, object_height, object_depth), and/or the like) of SRD sharing the same source_id value may be compared after taking into account the size of the reference space, i.e. after the object_x and object_width values are divided by the total_width value, the object_y and object_height values divided by the total_height value and the object_z and object_depth values divided by the total_depth value of their respective descriptors.

In some embodiments, different total_width, total_height and total_depth values could be used in different descriptors to provide positions and sizes information in different units.

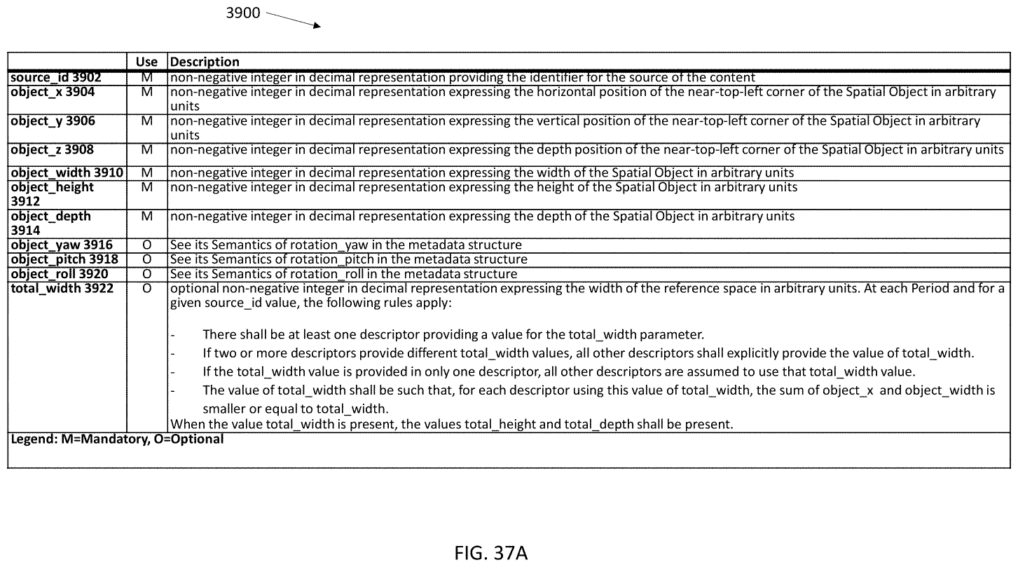

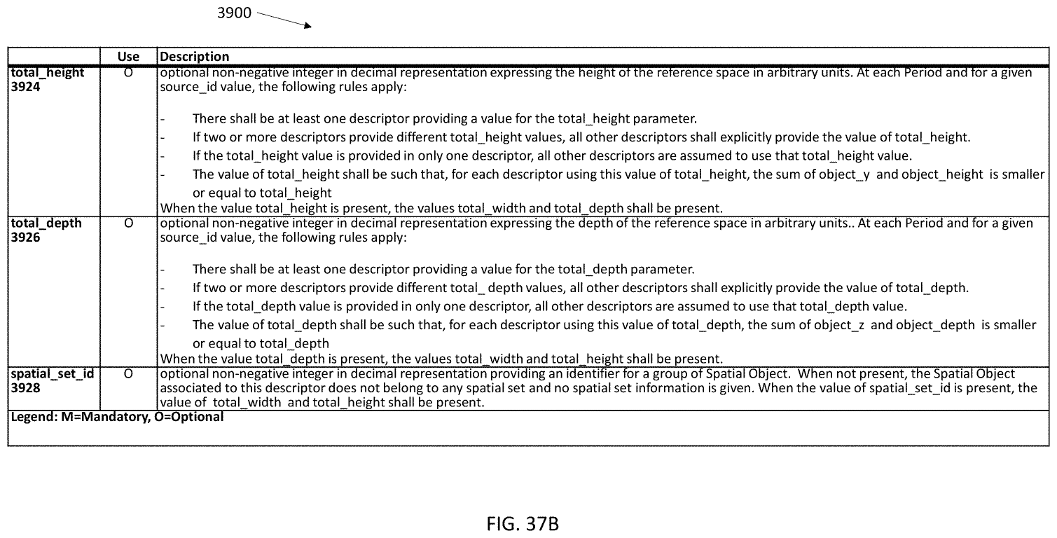

FIGS. 37A-37B show a table 3900 of exemplary EssentialProperty@value and/or SupplementalProperty@value attributes for the static SRD scheme, according to some embodiments. FIG. 37A shows the source_id 3902, the object_x 3904, the object_y 3906, the object_z 3908, the object_width 3910, the object_height 3912, the object_depth 3914, the object_yaw 3916, the object_pitch 3918, the object_roll 3920, and the total_width 3922. FIG. 37B shows the total_height 3924, total_depth 3926, and spatial_setid 3928. It should be appreciated that while various exemplary names and naming conventions are used throughout this application, such names are for exemplary purposes and are not intended to be limiting.

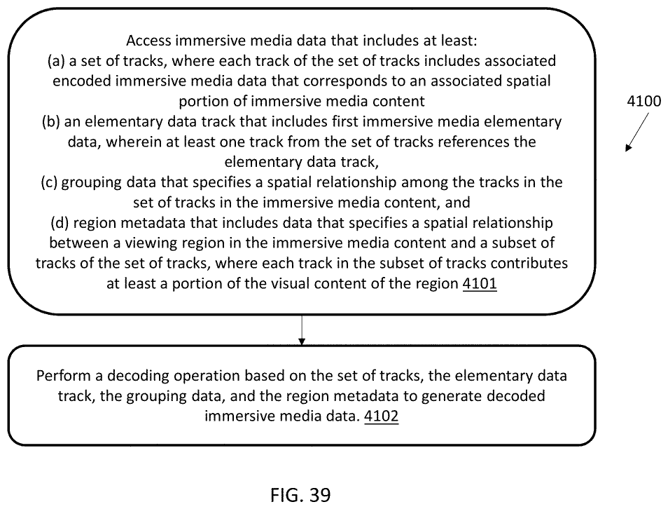

The table 3900 of FIGS. 37A-B may also be further extended to include other optional attributes for the source, such as total_x, total_y, and total_z for the location of the source, and total_pitch, total_yaw and total_roll for the rotation of the source. FIG. 39 shows an exemplary method 4100 for decoding video data for immersive media, according to some embodiments. The method comprises accessing and/or receiving immersive media data at step 4101 including (a) at least a set of tracks, where each track of the set of tracks includes associated encoded immersive media data that corresponds to an associated spatial portion of immersive media content (b) an elementary data track that includes immersive media elementary data, wherein at least one track from the set of tracks references the elementary data track. As described herein, for example, the elementary data track can be a parameter track, geometry track, texture track, and/or occupancy track. The immersive media data also includes (c) group data that specifies a spatial relationship among the tracks in the set of tracks in the immersive media content. The immersive media data also includes (d) region metadata comprising data that specifies a spatial relationship between a viewing region in the immersive media content and a subset of tracks of the set of tracks, where each track in the subset of tracks contributes at least a portion of the visual content of the region.

At step 4102, the method includes performing a decoding operation based on the set of tracks, the elementary data track, the grouping data, and the region metadata to generate decoded immersive media data. The immersive media content can be point cloud multimedia.

Accessing the immersive media data as in step 4101 of exemplary method 4100 may include accessing an immersive media bitstream including (a) a set of patch tracks, where each patch track corresponds to an associated track in the set of tracks, and (b) the elementary data track, wherein each patch track in the set of patch tracks references the elementary data track.

Accessing the immersive media data as in step 4101 of exemplary method 4100 may include accessing a set of immersive media bitstreams, where each immersive media bitstream may include (a) a track from the set of tracks, and (b) an associated elementary data track, wherein the track references the associated elementary data track, such that an immersive media bitstream from the set of immersive media bitstreams includes the elementary data track.

In some embodiments, the region may include a sub-portion of the viewable immersive media data that is less than a full viewable portion of the immersive media data. In some embodiments, the region may include a viewport.

According to some embodiments, accessing the region metadata 4101 (d) of method 4100 may include accessing a track grouping box in each track in the set of tracks. According to some embodiments, accessing the region metadata 4101 (d) of method 4100 may include accessing a timed metadata track that references the subset of tracks.

According to some embodiments, accessing the immersive media data as in step 4001 of exemplary method 4000 includes accessing a streaming manifest file that includes at least a track representation for each track in the set of tracks. In some examples, each track representation can be associated with a set of component track representations. In some examples, the streaming manifest file may include a descriptor that specifies the region metadata and/or include a timed metadata representation for a timed metadata track comprising the region metadata.

Various exemplary syntaxes and use cases are described herein, which are intended for illustrative purposes and not intended to be limiting. It should be appreciated that only a subset of these exemplary fields may be used for a particular region and/or other fields may be used, and the fields need not include the field names used for purposes of description herein. For example, the syntax may omit some fields and/or may not populate some fields (e.g., or populate such fields with a null value). As another example, other syntaxes and/or classes can be used without departing from the spirit of the techniques described herein.

Techniques operating according to the principles described herein may be implemented in any suitable manner. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

Further, some techniques described above comprise acts of storing information (e.g., data and/or instructions) in certain ways for use by these techniques. In some implementations of these techniques—such as implementations where the techniques are implemented as computer-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as computer-executable instructions, these instructions may be executed on one or more suitable computing device(s) operating in any suitable computer system, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

A computing device may comprise at least one processor, a network adapter, and computer-readable storage media. A computing device may be, for example, a desktop or laptop personal computer, a personal digital assistant (PDA), a smart mobile phone, a server, or any other suitable computing device. A network adapter may be any suitable hardware and/or software to enable the computing device to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media may be adapted to store data to be processed and/or instructions to be executed by processor. The processor enables processing of data and execution of instructions. The data and instructions may be stored on the computer-readable storage media.

A computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. A decoding method for decoding video data for immersive media, the method comprising:
accessing immersive media data comprising:
a set of tracks, wherein:
each track of the set of tracks comprises associated to-be-decoded immersive media data that corresponds to an associated spatial portion of immersive media content that is different than the associated spatial portions of other tracks in the set of tracks;
an elementary data track comprising first immersive media elementary data, wherein at least one track of the set of tracks references the elementary data track;
grouping data that specifies a spatial relationship among the tracks in the set of tracks in the immersive media content;
region metadata comprising data that specifies a spatial relationship between a viewing region in the immersive media content and a subset of tracks of the set of tracks, wherein each track in the subset of tracks contributes at least a portion of the visual content of the region; and
performing a decoding operation based on the set of tracks, the elementary data track, the grouping data, and the region metadata to generate decoded immersive media data.

2. The decoding method of claim 1, wherein accessing the immersive media data comprises:
accessing an immersive media bitstream comprising:
a set of patch tracks, wherein each patch track corresponds to an associated track in the set of tracks; and
the elementary data track, wherein each patch track in the set of patch tracks references the elementary data track.

3. The decoding method of claim 1, wherein accessing the immersive media data comprises:
accessing a set of immersive media bitstreams, wherein each immersive media bitstream comprises:
a track from the set of tracks; and
an associated elementary data track, wherein the track references the associated elementary data track,
such that an immersive media bitstream from the set of immersive media bitstreams comprises the elementary data track.

4. The decoding method of claim 1, wherein the region comprises a sub-portion of the viewable immersive media data that is less than a full viewable portion of the immersive media data.

5. The decoding method of claim 1, wherein the region comprises a viewport.

6. The decoding method of claim 1, wherein accessing the region metadata comprises accessing a track grouping box in each track in the set of tracks.

7. The decoding method of claim 1, wherein accessing the region metadata comprises accessing a timed metadata track that references the subset of tracks.

8. The decoding method of claim 1, wherein accessing the immersive media data comprises accessing a streaming manifest file that comprises a track representation for each track in the set of tracks.

9. The decoding method of claim 8, wherein each track representation is associated with a set of component track representations.

10. The decoding method of claim 8, wherein the streaming manifest file comprises a descriptor that specifies the region metadata.

11. The decoding method of claim 8, wherein the streaming manifest file comprises a timed metadata representation for a timed metadata track comprising the region metadata.

12. The decoding method of claim 1, wherein the immersive media content comprises point cloud multimedia.

13. The decoding method of claim 1, wherein the elementary data track comprises:
at least one geometry track comprising geometry data of the immersive media;
at least one attribute track comprising attribute data of the immersive media; and
an occupancy track comprising occupancy map data of the immersive media;
accessing the immersive media data comprises accessing:
the geometry data in the at least one geometry track;
the attribute data in the at least one attribute track; and
the occupancy map data of the occupancy track; and
performing the decoding operation comprises performing the decoding operation using the geometry data, the attribute data, and the occupancy map data, to generate the decoded immersive media data.

14. A method for encoding video data for immersive media, the method comprising:
encoding immersive media data, comprising encoding at least:
a set of tracks, wherein:
each track of the set of tracks comprises associated to-be-encoded immersive media data that corresponds to an associated spatial portion of immersive media content that is different than the associated spatial portions of other tracks in the set of tracks;
an elementary data track comprising first immersive media elementary data, wherein at least one track of the set of tracks references the elementary data track;
grouping data that specifies a spatial relationship among the tracks in the set of tracks in the immersive media content;
region metadata comprising data that specifies a spatial relationship between a viewing region in the immersive media content and a subset of tracks of the set of tracks, wherein each track in the subset of tracks contributes at least a portion of the visual content of the region; and
performing an encoding operation based on the set of tracks, the elementary data track, the grouping data, and the region metadata to generate encoded immersive media data.

15. The encoding method of claim 14, wherein encoding the immersive media data comprises:
encoding an immersive media bitstream comprising:
a set of patch tracks, wherein each patch track corresponds to an associated track in the set of tracks; and
the elementary data track, wherein each patch track in the set of patch tracks references the elementary data track.

16. The encoding method of claim 14, wherein encoding the immersive media data comprises:
encoding a set of immersive media bitstreams, wherein each immersive media bitstream comprises:
a track from the set of tracks; and
an associated elementary data track, wherein the track references the associated elementary data track,
such that an immersive media bitstream from the set of immersive media bitstreams comprises the elementary data track.

17. The encoding method of claim 14, wherein encoding the region metadata comprises encoding a track grouping box in each track in the set of tracks.

18. The encoding method of claim 14, wherein encoding the region metadata comprises encoding a timed metadata track that references the subset of tracks.

19. The encoding method of claim 14, wherein encoding the immersive media data comprises encoding a streaming manifest file that comprises a track representation for each track in the set of tracks.

20. A non-transitory computer-readable storage medium storing instructions that, when executed by a processor, cause the processor to perform a method, the method comprising:
accessing immersive media data comprising:
a set of tracks, wherein:
each track of the set of tracks comprises associated to-be-decoded immersive media data that corresponds to an associated spatial portion of immersive media content that is different than the associated spatial portions of other tracks in the set of tracks;
an elementary data track comprising first immersive media elementary data, wherein at least one track of the set of tracks references the elementary data track;
grouping data that specifies a spatial relationship among the tracks in the set of tracks in the immersive media content;
region metadata comprising data that specifies a spatial relationship between a viewing region in the immersive media content and a subset of tracks of the set of tracks, wherein each track in the subset of tracks contributes at least a portion of the visual content of the region; and
performing a decoding operation based on the set of tracks, the elementary data track, the grouping data, and the region metadata to generate decoded immersive media data.
